(19) United States
(12) Patent Application Publication
(10) Pub. No.: US 2025/0288955 A1
(43) Pub. Date: Sep. 18, 2025

(54) Apparatus and Method for Removal of Nitrogen Oxides from Exhaust Gas

(71) Applicant: EnergyLink Corporation, Calgary (CA)

(72) Inventors: Jeff Wirt, Tulsa, OK (US); Alan Monshaugen, Walnut Grove, MN (US)

(21) Appl. No.: 18/862,367

(22) PCT Filed: Dec. 4, 2023
(86) PCT No.: PCT/CA2023/051608

§ 371 Date: Nov. 1, 2024

Related U.S. Application Data
(60) Provisional application No. 63/430,188, filed on Dec. 5, 2022.
(60) Provisional application No. 63/540,208, filed on Sep. 25, 2023.

(51) Int. Cl. B01D 53/94

(52) U.S. Cl. CPC B01D 53/9418; B01D 2251/2062; B01D 2251/2067

(57) ABSTRACT

The present invention is directed towards an apparatus and method for the removal of one or more nitrogen oxides (NOx) from an exhaust gas stream of a combustion systems (for example exhaust gas from a gas turbine). In particular, a reducing agent is directly injected into a selected location in a duct system for the exhaust gas (for example at the inlet duct).

### TECHNICAL FIELD

The present invention is directed towards an apparatus and method for the removal of a portion of molecules of nitrogen oxides (NOx) from an exhaust gas stream from a combustion system, for example a gas turbine.

### BACKGROUND

Combustion systems such as gas turbines are commonly used to produce electricity by combusting natural gas, hydrogen, or fuel oil. By-products of the combustion process contained in exhaust gas stream from these combustion systems include carbon monoxide (CO) and various nitrogen oxides (NOx).

Both CO and NOx are harmful to the environment by introducing a toxic substance and/or aid in the creation of smog. Levels of NOx in the exhaust gas from a gas turbine are typically in the range of 10 to 400 ppm depending on the fuel and combustion system used for the combustion process. However, regulatory agencies in North America, Europe, and elsewhere in the world are currently restricting emission levels of NOx into the atmosphere to amounts as low as 2.0 to 2.5 ppm, with even stricter limits being considered. These limits necessitate treatment of the exhaust gas stream from combustion systems to remove a significant portion of the NOx before the exhaust gas stream is released into the atmosphere.

A known process used for the removal of NOx from the exhaust gas from a combustion system is a process commonly referred to as “selective catalytic reduction” or “SCR”. In this process, a reducing agent (for example aqueous ammonia, anhydrous ammonia, or urea) is injected into the exhaust gas stream upstream of a catalyst bed. The reducing agent reacts with the NOx in the exhaust gas stream over a catalyst bed which converts the NOx into by-products such as nitrogen and water. In the SCR process, the reducing agent must be in gas form as the mixture of reducing agent and exhaust gas stream passes through the catalyst bed. In addition, the vaporized reducing agent must be adequately distributed across the cross-section of the exhaust gas stream in accordance with specifications of the design of the SCR system so that the desired percentage of molecules of NOx are removed across the exhaust gas stream as it passes through the catalyst bed.

The reducing agents used in the SCR process are also typically harmful to the environment and/or have an odor. As such, emission levels of the reducing agents in the exhaust gas stream released into the atmosphere are also the subject of regulation and are typically restricted to in or about 5 to 10 ppm. Accordingly, the injection level of the reducing agent must be carefully regulated to ensure that the amount of reducing agent that passes through the catalyst bed unreacted (commonly referred to as “reducing agent slip”) is within these restrictions.

The SCR process used for the removal of NOx is typically implemented in a system where the exhaust gas stream from the combustion system travels through a duct system prior to being released to the atmosphere through a stack. The duct system typically includes an inlet duct attached to the combustion system exhaust duct, an expansion duct downstream of the inlet duct followed by a horizontal duct containing a reducing agent injection grid positioned upstream of a NOx catalyst bed. A CO catalyst bed may also be provided in the horizontal duct, either as a separate catalyst bed upstream of the injection grid or as a combined NOx/CO catalyst bed. The exhaust gas stream travels through the inlet duct at high velocity (when the term “velocity” is used herein in relation to the exhaust gas stream, unless otherwise specified, it is a reference to the actual velocity of the exhaust gas stream at actual operating conditions) and into the expansion duct. The cross-sectional area of the expansion duct increases in the direction of the flow of the exhaust gas stream, resulting in a reduction in the velocity of the exhaust gas stream. The exhaust gas stream may also be cooled as it travels through the expansion duct to a temperature range where the catalyst bed(s) incorporated in the system are effective. Catalyst beds known in the art typically have higher efficiency when the exhaust gas stream has a temperature within the range of approx. 800 to 900° F. for simple cycle operations. The exhaust gas stream from the combustion system may be at a temperature within this range or lower, but may also be higher, up to 1200° F. or higher. In systems where the exhaust gas stream is at these higher temperatures, the exhaust gas stream may be cooled prior to flowing through the catalyst bed(s) using a tempering air injection system, which mixes ambient air with the exhaust gas to reduce the exhaust gas stream temperature to the effective range of the catalyst bed(s). However, other suitable cooling arrangements can also be used.

Once the velocity and, if necessary, the temperature, of the exhaust gas stream has been reduced, the exhaust gas stream typically passes through a distribution grid at or near the entrance of the horizontal duct. The distribution grid is designed in a manner known in the art to distribute the flow of the exhaust gas stream across the cross-section of the horizontal duct to achieve an approximately even velocity profile. As referenced above, the exhaust gas stream may pass through a CO catalyst bed in the horizontal duct to remove the carbon monoxide molecules in the exhaust gas stream by converting the carbon monoxide to carbon dioxide. The exhaust gas stream then may flow through a reducing agent injection grid contained in the horizontal duct where a mixture of a vaporized reducing agent (for example aqueous ammonia, anhydrous ammonia, or urea) and a heated carrier gas is injected into the exhaust gas stream. The reducing agent injection grid is designed to extend across the cross-section of the duct with numerous injection zones to distribute the vaporized reducing agent and heated gas mixture across the flow of the exhaust gas stream. The exhaust gas stream containing the vaporized reducing agent then flows through a NOx catalyst bed which triggers a reaction between the NOx and the vaporized reducing agent which results in the removal of a percentage of the NOx.

The horizonal duct typically has a large cross-sectional area resulting in the exhaust gas stream travelling at a relatively low velocity (typically between approx. 20 to 25 ft/s when the combustion system is operating in a full load condition). This relatively low velocity reduces the pressure drop as the exhaust gas stream flows through the catalyst bed(s) and provides adequate time for the exhaust gas stream to travel through the catalyst bed(s) to allow the necessary reactions which remove the NOx to occur. The NOx catalyst bed is also positioned sufficiently downstream of the reducing agent injection grid to provide sufficient time for the distribution of the vaporized reducing agent to take place before the exhaust gas stream flows through the NOx catalyst bed. As referenced above, it is also known to use a combined catalyst bed designed to remove both CO and NOx. In such an arrangement, the reducing agent injection grid is positioned upstream of the combined catalyst bed to provide sufficient time to adequately distribute the vaporized reducing agent before the exhaust gas stream flows through the catalyst bed.

As referenced above, the reducing agent is injected through the injection grid in vapor form and with heated gas to distribute the reducing agent across the exhaust gas stream. As such, the SCR system includes a separate reducing agent vaporization system to meter and vaporize the reducing agent using hot gas prior to injection into the exhaust gas stream through the reducing agent injection grid. In particular, droplets of the liquid reducing agent are injected into a reaction chamber and a heat source is used to vaporize the liquid reducing agent into gas form. Two heat sources are typically used, namely (i) ambient air heated to a desired temperature by electric heaters and then circulated into the reaction chamber using blowers; or (ii) a portion of the hot exhaust gas is circulated by blowers into the reactor chamber.

The vaporized reducing agent along with the heated gas is sent by blowers from the reaction chamber to the reducing agent injection grid for injection into the exhaust gas stream flow. As referenced above, at the point of injection, the exhaust gas stream is at low velocity (typically between 20 to 25 ft/s when the combustion system is operating in a full load condition) and at a temperature which provides for a reaction within the NOx catalyst bed.

Once these steps are completed, the purified exhaust gas stream then flows up the stack, through a silencer and is released into the atmosphere at the top of the stack.

The performance of the SCR system is dependent, in part, upon the adequate distribution of the vaporized reducing agent across the cross-section of the exhaust gas stream at the inlet of the NOx catalyst bed. As such, it is known to provide valves or other flow control devices to vary the injection rates of the heated gas and vaporized reducing agent at different locations across the injection grid to achieve the desired distribution of the vaporized reducing agent. This is commonly referred to “tuning” the injection grid.

The distribution of the reducing agent across the cross-section of the exhaust gas stream at the inlet of the NOx catalyst bed is measured by a reducing agent-to-NOx root mean square (% RMS) analysis. In particular, measurements are taken at numerous evenly positioned points across the cross-section area of the catalyst bed. Based upon the measurements at each of the points, the % RMS was calculated using the following equations:

$$\% RMS = 100 \times {M}_{RMS}$$

$${M}_{RMS} = \frac{1}{M} \sqrt{\sum {( {M}_{i} - M )}^{2}}$$

Mᵢ=is the measurement for each point
M=the mean measurement for the points

The % RMS is a statistic that quantifies the variability of the reducing agent-to-NOx distribution across the gas stream at the inlet of the catalyst bed, with a lower % RMS indicating a more uniform distribution of the reducing agent. As referenced above, adjustments can be made to the valves or other flow control devices to change injection rates at different locations in the injection grid to provide a more uniform distribution.

A gas turbine can operate at a variety of load conditions ranging from a low load condition where the flow rate of the exhaust gas is the lowest to a full load condition where the flow rate is the highest. The design parameters for the SCR system determines the reducing agent-to-NOx % RMS at the inlet of the catalyst bed that is required for the operation of the system with the turbine at full load.

By way of example, the Haldor Topsoe chart below provides a series of reducing agent-to-NOx % RMS lines for an SCR system for a turbine operating at full load using ammonia as the reducing agent. The vertical axis lists the target amount of ammonia slip in parts per million (“ppm”) and the horizontal axis lists the target percent of NOx removal. For example, if the design parameters for the SCR system is to have, at full load conditions, no greater than 4 ppm slip of ammonia with at least a 92% removal of the NOx, the chart illustrates that the % RMS of the ammonia-to-NOx distribution at the inlet of the catalyst bed must be no more than 7% whereas if design parameters for the SCR system is to have at full load conditions no greater than 10 ppm slip of ammonia with at least a 92% removal of the NOx, the chart illustrates that the % RMS of the ammonia-to-NOx distribution at the inlet of the catalyst bed must be no greater than 15%. As such, the lower amount of ammonia slip required, at a given percentage of NOx removal, the lower the % RMS of the ammonia-to-NOx distribution. Similarly, the higher the percentage of NOx removal required, at a given ammonia slip, the lower the % RMS of the ammonia-to-NOx distribution.

In SCR catalyst bed design, the exhaust gas stream residence time within the catalyst bed is proportional to NOx removal. When a gas turbine is operating under a full load condition, the exhaust gas velocity will be the highest resulting in the shortest residence times within the catalyst bed. As such, the full load condition of the gas turbine governs the catalyst bed design, including the thickness of the catalyst bed, to ensure that exhaust gas has sufficient residence time for the required NOx removal. When a gas turbine operates under conditions lower than full load, exhaust gas velocities are lower which increases the residence time of the exhaust gas stream in the catalyst bed. With these higher residence times, NOx removal is increased and the system performance increases. As a result, under these lower load conditions, a higher % RMS of the ammonia-to-NOx distribution is permitted as compared to full load condition operation while still maintaining the treated exhaust gas within the design criteria in terms of percentage of NOx removal and the amount of ammonia slip.

A difficulty with the known SCR system is that the reducing agent vaporization system, reducing agent injection grid as well as the blowers and piping required to move the heated gases into the reaction chamber and vaporized reducing agent and heated gases from the reaction chamber to the reducing agent injection grid add cost and complexity to the system and increase the footprint required to install and operate the system.

### SUMMARY OF THE INVENTION

The following summary is provided to introduce the reader to the more detailed discussion to follow. The summary is not intended to limit or define the claims.

According to one broad aspect, a method of removing a portion of at least one type of nitrogen oxide from an exhaust gas stream flowing through a duct system is provided, the method comprising injecting a reducing agent into the exhaust gas stream at a point of injection wherein the exhaust gas stream is flowing with a flow turbulence at or after the point of injection causing the reducing agent to be distributed within the exhaust gas stream; passing the exhaust gas stream through an expansion zone in the duct system to a reduced velocity; passing the exhaust gas stream at the reduced velocity through a catalyst bed wherein the catalyst enables a reaction between the vaporized reducing agent and the at least one type of nitrogen oxide to remove a portion of the at least one type of nitrogen oxide from the exhaust gas stream.

In some examples, the method may include the reducing agent, at least in part, being a liquid when injected into the exhaust gas stream and the exhaust gas stream having a temperature at or after the point of injection that is greater than the vaporization temperature of the liquid reducing agent such that the liquid reducing agent is vaporized in the exhaust gas stream.

In other examples, the method may include passing the exhaust gas stream at the reduced velocity through a distribution grid prior to the catalyst bed to distribute the velocity of the exhaust gas stream across the cross-sectional area of the catalyst bed and/or the exhaust gas stream having a velocity in excess of about 29 ft/s at or after the point of injection of the liquid reducing agent at a full load condition.

In further examples, the method may include providing at least one injector wherein the at least one injector comprises a nozzle for injecting the liquid reducing agent into the exhaust gas stream; and the at least one injector can be adjusted to selectively position the nozzle at a plurality of locations within the exhaust gas stream; measuring a first distribution of the reducing agent upstream of the catalyst bed; changing the position of the nozzle of the at least one injector within the exhaust gas stream; measuring a second distribution of the reducing agent upstream of the catalyst bed; comparing the first distribution and the second distribution to determine a preferred location of the nozzle within the exhaust gas stream.

According to another broad aspect, an apparatus for removing a portion of at least one type of nitrogen oxide from an exhaust gas stream is provided, the apparatus comprising a duct system through which the exhaust gas stream flows; at least one injector for injecting a reducing agent into the exhaust gas stream at a point of injection wherein the exhaust gas stream is flowing with a flow turbulence at or after the point of injection causing the reducing agent to be distributed within the exhaust gas stream; an expansion zone in the duct system that reduces the velocity of the exhaust gas stream to a reduced velocity; and a catalyst bed positioned downstream of the expansion zone wherein the catalyst enables a reaction between the vaporized reducing agent and the at least one type of nitrogen oxide to remove a portion of the at least one type of nitrogen oxide from the exhaust gas stream.

In some examples, the apparatus may include the reducing agent being, at least in part, a liquid when injected into the exhaust gas stream and the exhaust gas stream having a temperature at or after the point of injection that is greater than the vaporization temperature of the liquid reducing agent such that the liquid reducing agent is vaporized in the exhaust gas stream.

In other examples, the apparatus may include a distribution grid in the duct system positioned upstream of the catalyst bed to distribute the velocity of exhaust gas stream across the cross-sectional area of the catalyst bed and/or the exhaust gas stream having a velocity in excess of about 29 ft/s at the point of injection of the liquid reducing agent at a full load condition.

According to another broad aspect, an apparatus for injecting a reducing agent into an exhaust gas stream flowing in a duct for the purpose of removing a portion of at least one type of nitrogen oxide from the exhaust gas stream is provided, the apparatus comprising at least one injector comprising a reducing agent inlet for receiving the reducing agent and a nozzle for injecting the reducing agent into the exhaust gas stream; a reducing agent supply line fluidly connected to the reducing agent inlet of the at least one injector for supplying the reducing agent to the injector; and at least one injector assembly to selectively position the nozzle of the injector at a plurality of locations within the duct.

In some examples, the apparatus may include the reducing agent being a liquid reducing agent and the apparatus further comprising at least one coolant system to insulate at least a portion of the at least one injector from the exhaust gas stream to prevent vaporization of the liquid reducing agent prior to being injected from the nozzle into the exhaust gas stream, wherein the at least one cooling system comprises at least one sleeve position within the duct wherein at least a portion of the at least one injector extends axially within the sleeve; a cooling gas supply line fluidly connected to the at least one sleeve; at least one axial cooling gas channel in the sleeve that extends around at least a portion the injector; wherein cooling gas flows from the cooling gas supply line through said at least one cooling gas channel to insulate at least a portion of the at least one injector; and wherein the sleeve further comprises a window through which the liquid reducing agent injected from the nozzle passes through and into the exhaust gas stream.

In other examples, the apparatus may include an injector gas supply line fluidly connected to the at least one injector; and wherein the at least one injector further comprises a gas channel through which gas from the injector gas supply line flows and is mixed with the liquid reducing agent prior to the liquid reducing agent being injected from the nozzle into the exhaust gas stream and/or the at least one injector assembly has channel and a clamping mechanism; the at least one injector extends axially through the channel of the at least one injector assembly; and the clamping mechanism has an unlocked position wherein the at least one injector can move axially within the channel of the at least one injector assembly and a locked position wherein the at least one injector is secured within the channel of the at least one injector assembly; wherein the clamping mechanism further comprises a seal to frictionally engage and seal the at least one injector in the channel of the at least one injector assembly when the clamping mechanism is in the locked position.

In further examples, the apparatus may include the at least one injector comprising a plurality of injectors; the reducing agent comprising a liquid reducing agent; the at least one injector assembly comprising a plurality of injector assemblies corresponding to each of the plurality of injectors; and wherein the apparatus further comprises a plurality of reducing agent valves corresponding to each of the plurality of injectors arranged to selectively allow the liquid reducing agent to flow from the reducing agent supply line into each of the plurality of injectors.

In yet further examples, the apparatus may include a coolant system to insulate at least a portion of each of the plurality of injectors from the exhaust gas stream to prevent vaporization of the liquid reducing agent prior to being injected from the nozzle into the exhaust gas stream wherein the cooling system comprises a plurality of sleeves position within the duct and corresponding to each of the plurality of injectors wherein at least a portion of the injector extends axially within the corresponding sleeve; a cooling gas supply line fluidly connected to the plurality of sleeves; at least one axial cooling gas channel in each of the plurality of sleeves that extends around at least a portion the corresponding injector that extends axially therein; wherein cooling gas flows from the cooling gas supply line through each of the cooling gas channels to insulate at least a portion of the corresponding injector that extends axially therein; and wherein the plurality of sleeves further comprises a window through which liquid reducing agent injected from the nozzle passes through and into the exhaust gas stream.

In yet further examples, the apparatus may further include an injector gas supply line fluidly connected to each of the plurality of injectors; wherein each of the plurality of injectors further comprises a gas channel through which gas from the injector gas supply line flows and is mixed with the liquid reducing agent prior to the liquid reducing agent being injected from the nozzle into the exhaust gas stream and/or each of the plurality of injector assemblies has channel and a clamping mechanism; each of the injectors extend axially through the channel of the corresponding injector assembly; and the clamping mechanism has an unlocked position wherein the injector can move axially within the channel of the injector assembly and a locked position wherein the injector is secured within the channel of the injector assembly; wherein the clamping mechanism of each of the plurality of injector assemblies further comprises a seal to frictionally engage and seal the corresponding injector in the channel when the clamping mechanism is in the locked position.

### BRIEF DESCRIPTION OF THE DRAWINGS

FIG. 1 is a cross-sectional view of a duct system for an exhaust gas stream emanating from a combustion process that incorporates a conventional SCR system.

FIG. 2 is a schematic diagram of a known reducing agent vaporization system used in a conventional SCR system.

FIG. 3 is a cross-sectional view of a duct system for an exhaust gas stream from a combustion process that incorporates an inlet duct with a direct reducing agent injection system in accordance with a first embodiment of the invention.

FIG. 4 is a top elevational view of the inlet duct with a direct reducing agent injection system in accordance with an embodiment of the invention as shown in FIG. 3.

FIG. 5 is downstream end view of the inlet duct with the direct reducing agent injection system in accordance with an embodiment of the invention as shown in FIG. 4.

FIG. 6 is a side elevational view of an injector and an exterior injector assembly for the direct reducing agent injection system in accordance with an embodiment of the invention as shown in FIG. 4.

FIG. 7 is a cross-sectional view of the injector and the exterior injector assembly shown in FIG. 6 along the line shown therein.

FIG. 8 is a perspective view of an installed injector and exterior injector assembly for the direct reducing agent injection system in accordance with an embodiment of the invention shown in FIG. 4.

FIG. 9 is side elevational view of an injector sleeve for the direct reducing agent injection system in accordance with an embodiment of the invention shown in FIG. 4.

FIG. 10 is a cross-sectional view of the injector sleeve shown in FIG. 9 along the line shown therein.

FIG. 11 is a cross-sectional view of the injector sleeve shown in FIG. 9 along the line shown therein.

FIG. 12 is a side elevational view of the inlet duct with a direct reducing agent injection system in accordance with a second embodiment of the invention.

FIG. 13 is downstream end view of the inlet duct with the direct reducing agent injection system in accordance with a second embodiment of the invention as shown in FIG. 12.

FIG. 14 is a perspective view of an installed injector and exterior injector assembly for the direct reducing agent injection system in accordance with a second embodiment of the invention shown in FIG. 12.

FIG. 15 is a side view of a plexiglass model of a duct system for an exhaust gas stream from a GE LM6000 PC gas turbine for model testing of a direct reducing agent injection system in accordance with a first embodiment of the invention.

FIG. 16 is a top view of the model as shown in FIG. 15.

FIG. 17A is a cross-sectional view of the inlet duct of the model as shown in FIG. 15 along the line shown therein.

FIG. 17B is a cross-sectional view of the inlet duct of the model as shown in FIG. 15 along the line shown therein.

FIG. 17C is a cross-section view of the injector sleeve shown in FIG. 17A along the line shown therein.

FIG. 18A is a side view of a portion of the model of duct system that contains the distribution grids as shown in FIG. 15.

FIG. 18B is a cross-section view of the portion of the model of the duct system shown in FIG. 18A along the line shown therein.

FIG. 18C is a cross-section view of the portion of the model of the duct system shown in FIG. 18A along the line shown therein.

FIG. 19 is a side view of a plexiglass model of a duct system for an exhaust gas stream from a Solar Titan 130 gas turbine for model testing of a direct reducing agent injection system in accordance with a first embodiment of the invention.

FIG. 20 is a top view of the model as shown in FIG. 19.

FIG. 21A is a side view of a portion of the model of duct system that contains the tempering air injection system as shown in FIG. 19.

FIG. 21B is a cross-section view of the portion of the model of the duct system shown in FIG. 21A along the line shown therein.

FIG. 21C is a cross-section view of the portion of the model of the duct system shown in FIG. 21A along the line shown therein.

FIG. 22A is a cross-sectional view of the inlet duct of the model as shown in FIG. 19 along the line shown therein showing a first embodiment of the injection system.

FIG. 22B is a cross-sectional view of the inlet duct of the model as shown in FIG. 19 along the line shown therein showing a second embodiment of the injection system.

FIG. 22C is a cross-section view of the injector sleeve shown in FIG. 22A along the line shown therein.

FIG. 23A is a side view of a portion of the model of the duct system that contains the distribution grids as shown in FIG. 19.

FIG. 23B is a cross-section view of the portion of the model of the duct system shown in FIG. 23A along the line shown therein.

FIG. 23C is a cross-section view of the portion of the model of the duct system shown in FIG. 23A along the line shown therein.

The drawings illustrate examples of aspects of the invention. Other features and advantages of the present invention will become apparent from the following description of the invention, and/or from the combination of one or more of the figures and the textual description herein, or from portions thereof.

### DETAILED DESCRIPTION

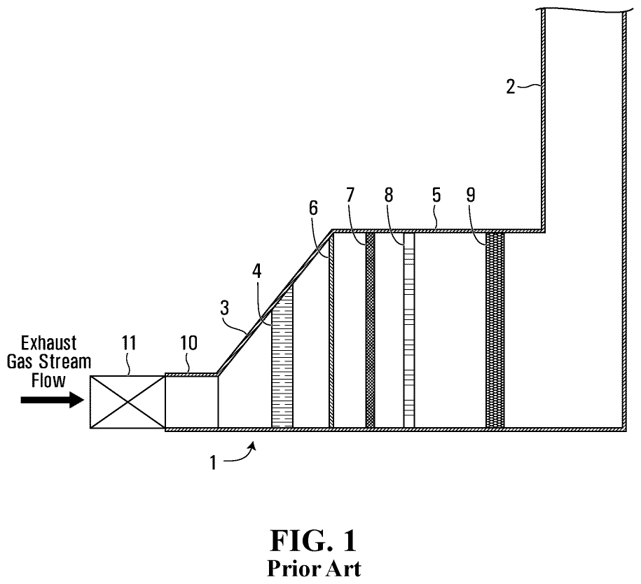

FIG. 1 shows a duct system 1 for an exhaust gas stream emanating from a combustion system (for example a gas turbine) that incorporates a known SCR system. As shown in FIG. 1, the duct system includes a series of ducts connected to an exhaust gas outlet 11 of a combustion system (not shown). The exhaust gas stream flows from the exhaust gas outlet 11 along an axial length of the duct system 1 and is released into the atmosphere out of the top of a stack 2. In the embodiment shown in FIG. 1, the duct system 1 includes an inlet duct 10 connected to the exhaust gas outlet 11 of combustion system and an expansion duct 3 and a horizontal duct 5 downstream of the inlet duct.

The exhaust gas stream from the combustion process exits the exhaust gas outlet 11 into the inlet duct 10 at high velocity. The exhaust gas stream flows through the inlet duct 10 to the expansion duct 3 which expands in cross-section to slow the velocity of the exhaust gas stream. If required, a tempering air injection system 4 may be incorporated in the expansion duct 3 which mixes ambient air with the exhaust gas to reduce the exhaust gas stream temperature to a range where the catalyst bed(s) discussed below are effective. As referenced above, catalyst beds typically have higher efficiency when the exhaust gas stream has a temperature within the range of approx. 800 to 900° F. for simple cycle operations but can be effective over a broader range of temperatures. While the embodiment shown in FIG. 1 incorporates a tempering air injection system to cool the exhaust gas stream, other suitable cooling arrangements may also be used to cool the exhaust gas stream if required.

The horizontal duct 5 is downstream of the expansion duct 3. A distribution grid 6 is positioned at or near the beginning of the horizontal duct 5 that distributes the flow velocity of the exhaust gas stream across the cross-sectional area of the horizontal duct in a manner known to a person skilled in the art. Downstream of the distribution grid, a CO catalyst bed 7 may be provided to remove carbon monoxide in the exhaust gas stream, for example by converting the carbon monoxide to carbon dioxide in a manner known to a person skilled in the art. The exhaust gas stream then flows through a reducing agent injection grid 8 where a mixture of a vaporized reducing agent and hot gas is injected. The reducing agent injection grid 8 is designed to extend across the cross-section of the horizontal duct 5 with numerous injection zones to distribute a mixture of vaporized reducing agent and hot gas across the flow of the exhaust gas stream. The reducing agent injection grid 8 may include valves or other flow devices (not shown) to adjust the injection rate of the vaporized reducing agent and hot gas at different locations in the injection grid to improve the distribution of the reducing agent. The exhaust gas stream containing the vaporized reducing agent then flows through a NOx catalyst bed 9 which triggers the reaction between the vaporized reducing agent and the NOx to produce by-products such as nitrogen and water as would be understood by a person skilled in the art.

The horizontal duct 5 has a large cross-sectional area resulting in the exhaust gas stream travelling at a low velocity (for example between 20 to 25 ft/s when the combustion system is operating in a full load condition). The low velocity of the exhaust gas stream reduces the pressure drop as the stream flows through the catalyst beds and provides adequate time for the stream to travel through the CO catalyst bed 7 and the NOx catalyst bed 9 to allow the reactions to remove the CO and NOx to occur. The NOx catalyst bed 9 is positioned at a distance downstream of the reducing agent injection grid 8 to provide sufficient time for the distribution of the vaporized reducing agent across the exhaust gas stream before the exhaust gas stream flows through the NOx catalyst bed. The purified exhaust gas stream leaving the NOx catalyst bed 9 then flows up the stack 2, through a silencer (not shown) and is released into the atmosphere at the top of the stack.

In an alternative arrangement (not shown), a combined catalyst bed designed to remove both CO and NOx may be provided in the horizontal duct 5 to replace the CO catalyst bed 7 and the NOx catalyst bed 9. In this arrangement, the combined catalyst bed is positioned downstream of the reducing agent injection grid 8. As a result of the removal of one of the catalyst beds, the reducing agent injection grid 8 and combined catalyst bed may be moved further upstream closer to the distribution grid 6 if a second distribution grid is not required to replace the evening of the flow of the exhaust gas stream resulting from the passing through the CO catalyst bed 7. However, in this arrangement, the reducing agent injection grid 8 still must be positioned sufficiently upstream of the combined catalyst bed to provide sufficient time for the vaporized reducing agent distribution to take place before the exhaust gas stream flows through the NOx catalyst bed.

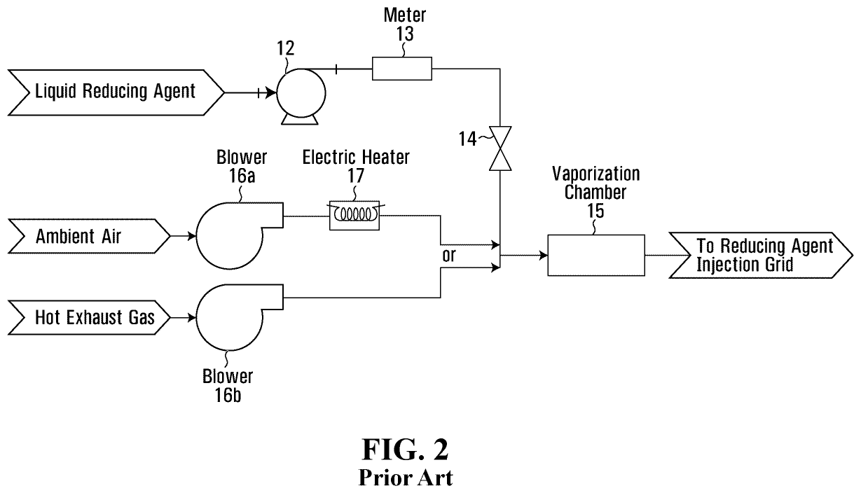

The known SCR system in FIG. 1 also includes a separate reducing agent vaporization system to meter and vaporize the reducing agent prior to injection into the exhaust gas stream through the reducing agent injection grid 8. A schematic drawing of an embodiment of a reducing agent vaporization system is shown in FIG. 2. The liquid reducing agent is pumped by a pump 12 through a meter 13 which measures the amount of liquid reducing agent that is injected. The liquid reducing agent then flows through a control valve 14 and passes through an injector (not shown) into a stream of heated carrier gas as it enters a vaporization chamber 15. The injector is designed to atomize the liquid reducing agent into small droplets in a manner known to a person skilled in the art which facilitates the vaporization of liquid reducing agent when contacted with the heated gas in the vaporization chamber 15. The mixture of heated carrier gas and vaporized reducing agent then flows to the reducing agent injection grid 8 for injection into the exhaust gas stream.

As shown in FIG. 2, the heated carrier gas may be supplied from two alternative sources, namely (i) ambient air passing through a blower 16a which is then heated to a desired temperature by an electric heater 17; or (ii) a portion of the hot exhaust gas from the combustion system is circulated by a blower 16b. It is understood by a person skilled in the art that other sources of heated gas may also be used. The heated carrier gas supplied is typically in the range of 600° F. to 1000° F.

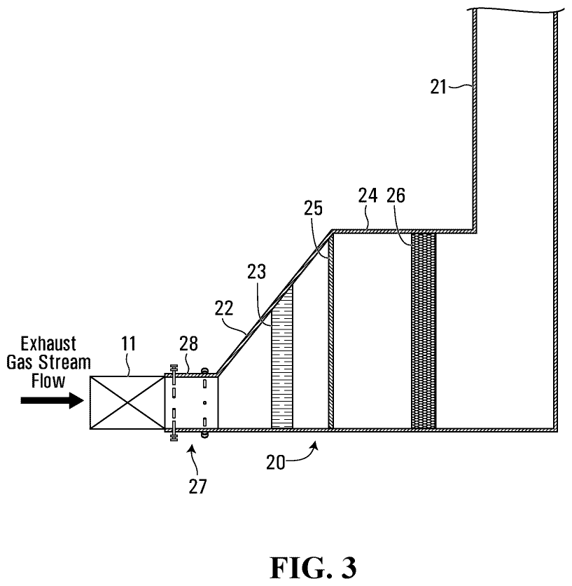

FIG. 3 shows a duct system 20 for an exhaust gas stream emanating from a combustion system that incorporates an SCR system that includes a reducing agent direct injection system in accordance with an embodiment of the invention. As shown in FIG. 3, the exhaust gas stream from the combustion system exiting from the exhaust outlet 11 flows along an axial length of the duct system 20 and is released into the atmosphere out of the top of a stack 21. In the embodiment shown in FIG. 3, the duct system 20 includes an inlet duct 28 connected to the exhaust gas outlet 11 of combustion system and an expansion duct 22 and a horizontal duct 24 downstream of the inlet duct 28.

The exhaust gas stream from the combustion process exits the exhaust gas outlet 11 into the inlet duct 28 at high velocity and temperature. The exhaust gas stream flows through the inlet duct 28 to the expansion duct 22 which expands in cross-section thereby reducing the exhaust gas stream velocity. If required, a tempering air injection system 23 may be incorporated in the expansion duct 22 which mixes ambient air with the exhaust gas stream to reduce the temperature of the exhaust gas stream to a temperature range where the catalyst bed is more effective as previously discussed. It would be understood by a person skilled in the art that other types of cooling systems may be used to reduce the temperature of the exhaust gas stream.

The horizontal duct 24 is downstream of the expansion duct 22. A distribution grid 25 may be positioned at or near the beginning of the horizontal duct 24 to distribute the flow velocity of the exhaust gas stream across the cross-section of the horizontal duct 24. Downstream of the distribution grid 25, a catalyst bed 26 may be provided. The catalyst bed 26 is designed to remove both CO and NOx from the exhaust gas stream. The CO is converted to carbon dioxide whereas the NOx reacts with a vaporized reducing agent injected into the exhaust gas stream discussed in greater detail below resulting in by-products such as nitrogen and water in a manner that is understood by a person skilled in the art. The reducing agent coming into contact with the carbon monoxide catalyst in the catalyst bed results in a small amount of additional NOx being formed. However, the catalyst bed may be designed in a manner known to a person skilled in the art to account for and remove the additional NOx created.

The horizontal duct 24 has a large cross-sectional area resulting in the exhaust gas stream travelling at a low velocity (typically between 20 to 25 ft/s when the combustion system is operating in a full load condition). As discussed above, the low velocity of the exhaust gas stream reduces the pressure drop as the exhaust gas stream flows through the catalyst bed and provides adequate time for the exhaust gas stream to travel through the catalyst bed 26 to allow the reactions converting the CO and NOx to occur.

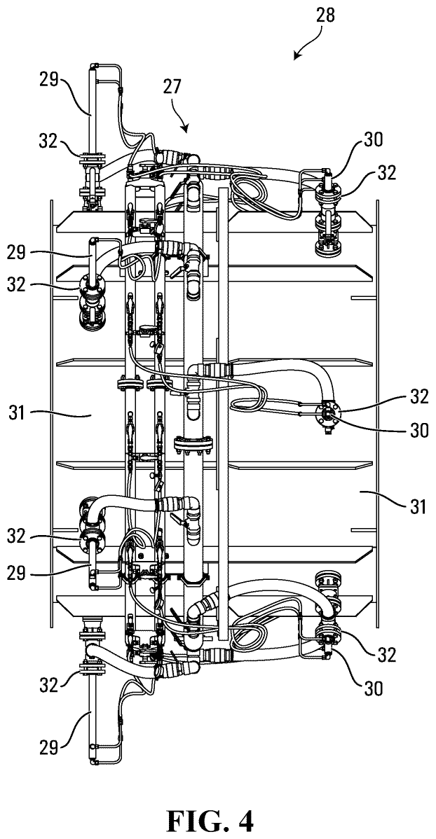

As shown in FIG. 3 and FIG. 4, a first embodiment of a reducing agent direct injection system 27 is provided in the inlet duct 28 to inject droplets of liquid reducing agent into the exhaust gas stream. As the exhaust gas stream enters the inlet duct 28 from the exhaust gas outlet 11, the exhaust gas stream for common gas turbines operating at a full load condition can flow at a velocity in the range of approximately 95 to 325 ft/s or higher and has a temperature in the range of approximately 675° F. to 1200° F. or higher as shown in Table 1 below. The heat, high velocity, and turbulence of the exhaust gas flow in the inlet duct vaporizes the droplets of liquid reducing agent and mixes the vaporized liquid reducing agent within the exhaust gas stream.

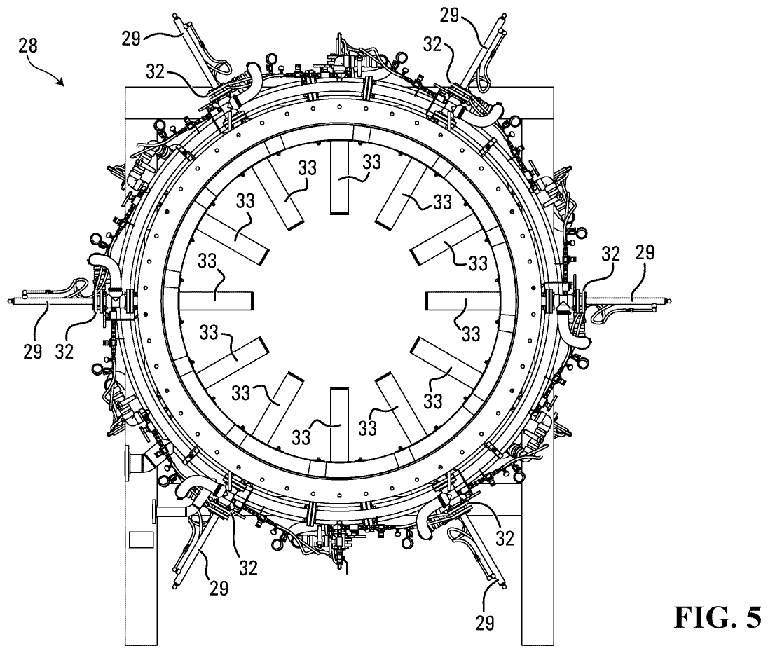

A first embodiment of the reducing agent direct injection system 27 is shown in FIG. 4 and FIG. 5. As shown, the reducing agent direct injection system 27 includes a first series of liquid reducing agent injectors 29 and a second series of liquid reducing agent injectors 30 positioned downstream thereof. In the embodiment shown, each of the series liquid reducing agent injectors 29 and 30 comprise six injectors that pass through an external injector assembly 32, a channel (not shown) in a side wall 31 of the inlet duct 28 and into a corresponding injector sleeve 33 in the interior of the inlet duct 28. Each of the series of injectors 29 and 30 may be spaced at equal distances around the circumference of the side wall 31 of the inlet duct. The second series of injectors 30 may be rotated relative to the first series of injectors 29. In the embodiment shown, the second series of injectors 30 are rotated 30 degrees relative to the first series of injectors 29.

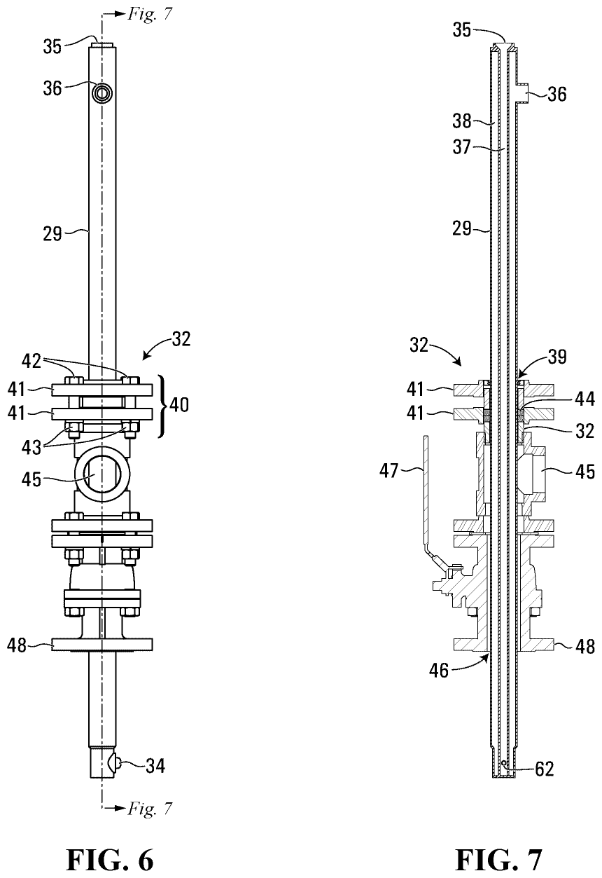

FIG. 6 and FIG. 7 show one of the first series of injectors 29 positioned within one of the external injector assemblies 32. In the embodiment shown, each of the first series of injectors 29 and each of the second series of injectors 30 and external injector assemblies 32 are designed and operate in an identical manner as discussed below.

As shown in FIG. 6 and FIG. 7, the injector 29 is an elongated cylinder that extends through the external injector assembly 32 with a nozzle 34 at one end and a reducing agent port 35 and a gas port 36 at the other end. As shown in FIG. 7, the injector 29 has a reducing agent channel 37 which extends axially along the length of injector. Liquid reducing agent injected in the reducing agent port 35 flows through the reducing agent channel 37 and out of an outlet 62 adjacent to the nozzle 34 at the bottom of the injector. The injector 29 also includes an annular gas channel 38 which surrounds the reducing agent channel 37 and extends the length of injector 29. A gas, for example ambient air or other suitable gas, can be injected through the gas port 36 which then flows through the injector in gas channel 38 to the nozzle 34.

The nozzle 34 is designed to atomize the liquid reducing agent into small droplets to improve vaporization and distribution of the reducing agent when injected into the exhaust gas stream in the inlet duct 28. The gas mixes with the liquid reducing agent flowing out of the outlet 62 prior to mixture of gas and reducing agent passing through the nozzle 34. The gas assists with the atomization of the liquid reducing agent as it passes through the nozzle 34 as would be understood by a person skilled in the art. The gas also serves to insulate the liquid reducing agent from heat from the exterior of the injector (for example from the exhaust gas stream) to prevent the liquid reducing agent from vaporizing prior to it being released through the nozzle 34. The injector 29 may be an injector from the RAD series manufactured by Environex which is designed to atomize the liquid reducing agent into droplets that are typically less than 100 microns in diameter.

The injector 29 extends through an axial channel 39 in the external injector assembly 32. The axial channel 39 is sized to permit movement of the injector 29 axially within the channel. The external injector assembly 32 includes a clamping mechanism 40 comprising two radial flanges 41, a series of bolts 42, a series of nuts 43 and packing material 44 (as shown in FIG. 7). In the released position, namely when the bolts 42 and the nuts 43 are loosened, the injector 29 can move axially within the axial channel 39 to adjust the radial position of the nozzle 34 in corresponding injector sleeve 33 as discussed in greater detail below. When the bolts 42 and the nuts 43 are tightened, the radial flanges 41 move towards one another thereby compressing packing material 44. Packing material 44 is typically comprised of graphite or similar material, which, upon compression extends radially towards the injector 29 creating a frictional engagement that prevents the injector 29 from moving within the axial channel 39. The packing material 44 also acts as a seal to prevent gas (for example gas from the exhaust gas stream) from flowing through the clamping mechanism 40.

The external injector assembly 32 also includes a coolant port 45 through which a coolant (for example ambient air or other suitable gas) may be injected. The diameter of channel 39 below the coolant port 45 is greater than the diameter of the injector 29 resulting in an annular recess 46 between the external injector assembly 32 and the injector 29. As such, the coolant entering into the coolant port 45 flows downward through the annual channel 46 towards the injector sleeve 33. The coolant is used to insulate the injector 29, including the portion that extends into the injector sleeve 33 as discussed in greater detail below.

The external injector assembly 32 also includes a lever 47 connected to a valve assembly (not shown). The lever 47 moves the valve assembly from an open position wherein the injector 29 can be inserted in the axial channel 39 to a closed position where the axial channel 39 is sealed. Accordingly, if the injector 29 is removed from the external injector assembly 32, the valve assembly can be closed to prevent the flow of gas from the exhaust gas stream through the external injector assembly 32.

The external injector assembly 32 also includes a lower radial flange 48 for connecting the external injector assembly 32 to the side wall 31 of the inlet duct 28. The lower radial flange 48 can be connect to the side wall 31 by welding, a bolt and nut assembly or other suitable arrangement.

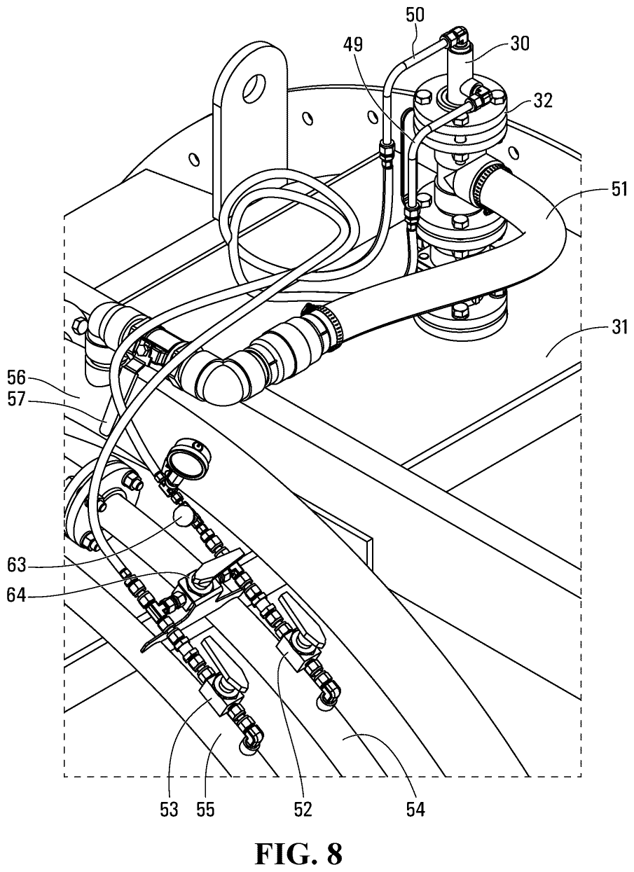

As shown in FIG. 8, when the injector 29 and externally injector assembly are installed on the side wall 31 of the inlet duct, a gas line 49 is run from a gas supply tube 55 and connected to the gas port 36 of the injector 29. Similarly, a reducing agent line 50 is run from a reducing agent supply tube 54 and connected to the reducing agent port 35 of the injector 29. In addition, a coolant line 51 is run from a coolant supply tube 56 and connected to the coolant port 45 of the external injector assembly 32.

A flow valve 52 is provided in the reducing agent line 50 to control the flow of liquid reducing agent through the line by manually adjusting the position of the valve from an open position to a closed position. A reducing agent metering valve 63 is also provided to vary the flow rate of the reducing agent through the reducing agent line 50. The reducing agent metering valve 63 in the reducing agent line 50 for each of the injectors 29 and 30 may be independently adjusted to inject the liquid reducing agent at different rates. A flow valve 53 is provided in the gas line 49 to control the flow of gas through the line by manually adjusting the position of the valve from an open position to a closed position. The flow valve 53 in the gas line 49 for each of the injectors 29 and 30 may be adjusted to inject the gas through some or all of the injectors. A flow valve 57 is provided in the coolant line 51 to control the flow of coolant through the line by manually adjusting the position of the valve from an open position to a closed position. The flow valve 57 in the coolant line 51 for each of the external injector assemblies 32 may be adjusted to inject the coolant through some or all of the external injector assemblies. A purging valve 64 is provided in a line connecting the gas line 49 and the reducing agent line 50. When the flow valve 52 is in the closed position, the purging valve 64 can be opened to allow the flow of gas from the gas line 49 to flow through the reducing agent line 50 to purge the remaining reducing agent from the reducing agent line 50 and the injector 29.

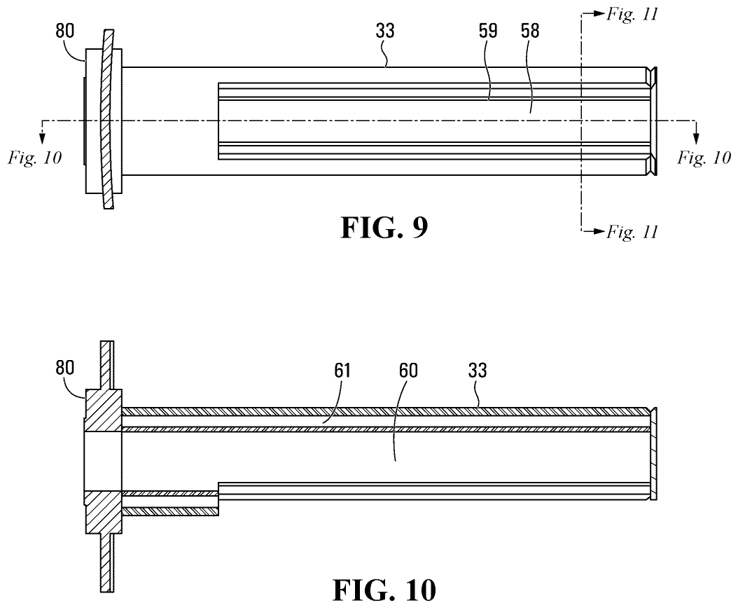

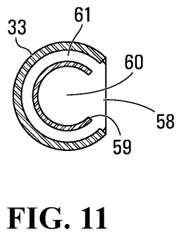

As discussed above, each of the injectors 29 and 30 extend through a channel (not shown) in the side wall 31 of the inlet duct 28 and into the corresponding injector sleeve 33 as shown in FIG. 5. As shown in FIG. 9 to FIG. 11, each of the injector sleeves 33 has an elongated tubular shape with a window 58 cut in portion of the side wall. An interior tubular wall 59 extends axially in the injector sleeve defining an internal channel 60 and an external annular channel 61. Each of the injectors 29 or 30 extends into the internal channel 60 of the corresponding sleeve 33 such that the nozzle 34 is positioned within and directed radially outward towards the window 58 so that the droplets of liquid reducing agent ejected from the nozzle 34 pass through the window 58 and into the exhaust gas stream flowing through the inlet duct 28. The external annular channel 61 is connected to the annular recess 46 in the external injector assembly 32 such that the coolant injected through the coolant port 45 flows through the annular recess 46 and the side wall 31 of the inlet duct 28 and into the external annular channel 61 of the sleeve 33. This flow of coolant serves to insulate the injector from the high temperatures of the exhaust gas flow in the inlet duct 28 so that the liquid reducing agent is not vaporized prior to exiting the nozzle 34 of the injector.

Each of the injector sleeves 33 include a radial flange 80 which is connected to the inner side wall of the inlet duct 28. As shown in FIG. 5, each of the sleaves 33 is oriented such that the window 58 therein faces downstream of the exhaust gas stream flow so that the window cannot be seen when looking downstream in the inlet duct 28. This arrangement minimizes stress on the sleeves 33 and the injectors 29 and 30 caused by the exhaust gas stream flow and the amount exhaust gas that flows into the window 58.

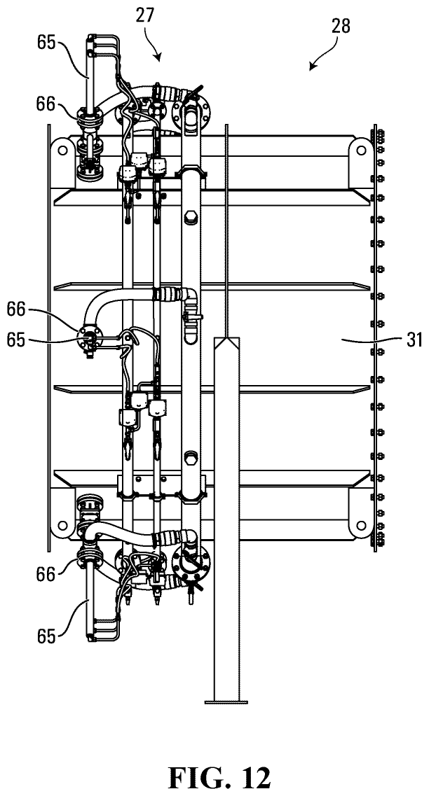

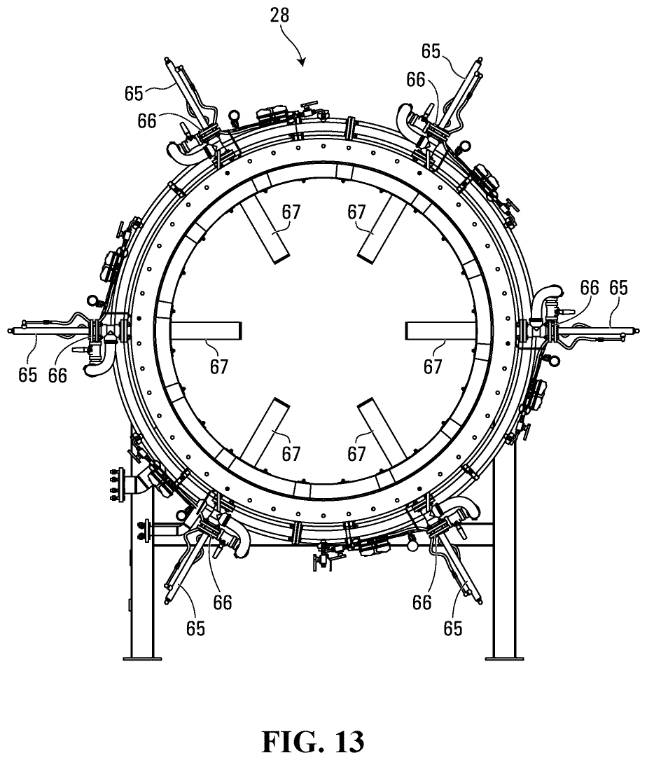

A second embodiment of the reducing agent direct injection system 27 is shown in FIG. 12 to FIG. 14. As shown, the second embodiment of the reducing agent direct injection system 27 includes a single series of liquid reducing agent injectors 65. In the embodiment shown, the series liquid reducing agent injectors 65 comprise six injectors that pass through an external injector assembly 66, a channel (not shown) in the side wall 31 of the inlet duct 28 and into a corresponding injector sleeve 67 in the interior of the inlet duct 28. The series of injectors 65 may be spaced at equal distances around the circumference of the side wall 31 of the inlet duct 28. Each of the injectors 65, the external injector assemblies 66 and the injector sleeves 67 are designed and operate in an identical manner as each of the injectors 29 and 30, the external injector assemblies 32 and the injector sleeves 33 discussed above and shown in FIG. 6, FIG. 7 and FIG. 9 to FIG. 11.

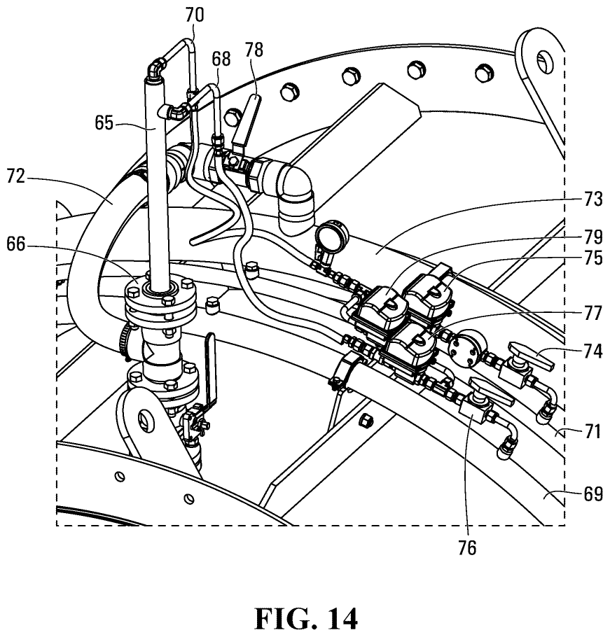

As shown in FIG. 14, when the injector 65 and the externally injector assembly 66 are installed on the side wall 31 of the inlet duct, a gas line 68 is run from a gas supply tube 69 and connected to the gas port 36 of the injector 65. Similarly, a reducing agent line 70 is run from a reducing agent supply tube 71 and connected to the reducing agent port 35 of the injector 65. In addition, a coolant line 72 is run from a coolant supply tube 73 and connected to the coolant port 45 of each of the external injector assemblies 66.

A metering valve 74 is provided in the reducing agent line 70 to vary the flow rate of the reducing agent through the reducing agent line 70. An electronic actuated valve 75 is also provided in the reducing agent line 70 which can be remotely switched from an open position (which allows the flow of reducing agent) to a closed position (which prohibits the flow of reducing agent). The electronic actuated valve 75 in the reducing agent line 70 for each of the injectors 65 may be adjusted to inject the reducing agent through some or all of the injectors 65.

A metering valve 76 is provided in the gas line 68 to vary the flow rate of the gas through the gas line 68. An electronic actuated valve 77 is also provided in the gas line 68 which can be remotely switched from an open position (which allows the flow of gas) to a closed position (which prohibits the flow of gas). The electronic actuated valve 77 in the gas line 68 for each of the injectors 65 may be adjusted to inject the gas through some or all of the injectors 65.

A flow valve 78 is provided in the coolant line 72 to control the flow of coolant through the line by manually adjusting the position of the valve from an open position to a closed position. The flow valve 78 in the coolant line 72 for each of the external injector assemblies 66 may be adjusted to inject the coolant through some or all of the external injector assemblies.

An electronic actuated purging valve 79 is provided in a line connecting the gas line 68 and the reducing agent line 70. When the electronic actuated valve 75 is in the closed position, the electronic actuated purging valve 79 can be opened to allow the flow of gas from the gas line 68 to flow through the reducing agent line 70 to purge the remaining reducing agent from the reducing agent line 70 and the injector 65.

The inclusion of the electronic actuated valve 75, the electronic actuated valve 77 and the electronic actuated purging valve 79 allows for the flow of reducing agent and gas to each of the injectors 65, as well as the ability to purge each of the injectors 65, to be controlled from a remote location.

The total amount of reducing agent to be injected through the series of injectors 29 and 30 in the first embodiment of the reducing agent directed injection system 27 or the injectors 65 in the second embodiment of the reducing agent directed injection system 27 is calculated for particular flow rates of the exhaust gas stream based upon the concentration of NOx in the stream and measurements of the NOx level in the exhaust gas stream downstream of the catalyst bed 26. In operation, a feedback loop may be provided which automatically adjusts the injection rate of the liquid reducing agent based upon these calculations and a measurement of the exhaust gas stream flow rate. The reducing agent level may also be measured downstream of the catalyst bed 26 (for example at the top of the stack 21) to ensure the reducing agent slip is below a specified amount. An alarm system may be provided which is activated if the reducing agent level at the top of the stack 21 exceeds the specified amount. It would be understood by a person skilled in the art that other suitable arrangements for measuring the reducing agent slip could also be used.

The flow conditions of the exhaust gas stream of different combustion systems can vary. By way of example, the table below shows the range of exhaust gas stream flow conditions of several known gas turbines operating at a full load condition. The ranges of flow rate, and exhaust temperature are created by changing ambient air temperatures which impact gas turbine performance. These flowrates and temperatures as a function of ambient air temperatures are provided by the gas turbine manufacturers. Actual velocity is the actual flowrate of exhaust gas provided by the manufacturer divided by the area of the exhaust flange.

TABLE 1

| | Exhaust | Exhaust | | | | Actual | |
|---|---|---|---|---|---|---|---|
| | Flow Rate | Flow Rate | Exhaust | Exhaust | Exhaust | Velocity | Actual |
| | (Min) | (Max) | Temp. | Temp. | Flange | (Min) | Velocity |
| Gas Turbine | ACFM | ACFM | (Min) ° F. | (Max) ° F. | Area ft² | ft/s | (Max) ft/s |
| GE LM6000 | 512,846 | 591,135 | 793 | 861 | 35.8 | 239 | 275 |
| PC | | | | | | | |
| GE LM6000 PF | 409,736 | 670,141 | 677 | 995 | 34.5 | 198 | 324 |
| (Sprint) | | | | | | | |
| GE LM2500 | 322,191 | 440,788 | 873 | 988 | 31.3 | 172 | 235 |
| GE 7FA.04 | 2,256,656 | 2,754,479 | 1,082 | 1,164 | 201.1 | 187 | 228 |
| Solar Titan 130 | 164,251 | 257,553 | 679 | 1,037 | 27.9 | 98 | 154 |
| Solar Titan 250 | 258,326 | 316,515 | 820 | 849 | 33.8 | 128 | 156 |
| Solar Titan 350 | 436,242 | 525,624 | 888 | 1,001 | 60.3 | 121 | 145 |

“ACFM” = Actual cubic feet per minute.

These different flow conditions as well as other operating parameters (for example the duct system design) result in different dynamic flow patterns in the exhaust gas stream as it passes through the inlet duct. The dynamic flow pattern of the exhaust gas stream also changes when the load level of a particular combustion system is changed (for example moving from a full load condition to a partial load condition or a partial load condition to a low load condition).

The reducing agent direct injection system discussed above provides the ability to make a variety of independent adjustments including adjusting the number of injectors 29 and 30 in the first embodiment and the number of injectors 65 in the second embodiment being used to inject reducing agent, the nozzle position within the inlet duct 28 of each of the injectors 29 and 30 in the first embodiment and the injectors 65 in the second embodiment being used and the liquid reducing agent injection rate of each the injectors 29 and 30 in the first embodiment and the injectors 65 in the second embodiment. This arrangement provides the ability to modify the reducing agent direct injection system to find an optimal configuration for mixing and vaporization of the reducing agent in the exhaust gas stream of a particular system operating at a particular load level. In particular, the arrangement of the system can be adjusted to determine an arrangement that provides a desired % RMS distribution of the vaporized reducing agent at the inlet of the catalyst bed 26.

Since the embodiments of the invention discussed above uses the temperature, velocity and turbulence of the exhaust gas stream to vaporize and mix the reducing agent within the exhaust gas stream, it does not require several of the elements found in the conventional SCR system such as (i) the reducing agent injection grid 8 extending across the cross-section of the horizontal duct, (ii) the reducing agent vaporization system to vaporize the reducing agent prior to injection, and (iii) the piping, electric heaters (if needed) and blowers required to draw, heat and circulate the hot gas into the reaction chamber as the heating source to vaporize the reducing agent and to move the vaporized reducing agent and gases from the reaction chamber to the reducing agent injection grid. This reduces both capital and operating costs. Also, by eliminating the reducing agent injection grid and one of the catalyst beds, the axial length of the duct system 20 may be shortened as compared to the duct system 1 of the known SCR system thereby reducing the distance required between the combustion source and the stack. As a result, the invention may not only reduce the amount of equipment required for the SCR system, but it may also reduce the overall footprint required to install the SCR system, thereby resulting in further cost savings.

In addition, the embodiments of the invention discussed above can be used with a variety of reducing agents, for example aqueous ammonia, anhydrous ammonia, or urea.

While the inlet duct of the first and second embodiments of the invention has a circular cross-section, it would be understood by a person skilled in the art that the exhaust gas outlets of combustion systems such as turbines have different shapes, including circular, oval, rectangular and square. As such, it would be understood by a person skilled in the art that the shape of the inlet duct cross-section could be modified to accommodate the shape of the exhaust gas outlet of the combustion system and the positioning of the injectors adjusted accordingly. As such, reducing agent direct injection system discussed above can be modified to accommodate the configurations of the exhaust gas outlets of different combustion systems.

While the reducing agent injectors, injector assemblies and injector sleeves in the first and second embodiments of the invention have been described having specific designs, it is understood by a person skilled in the art that different injectors, injector assemblies and injector sleeves may be designed to achieve the same objectives and used in a reducing agent direct injection system 27 in accordance with this invention. In addition, while the design of the reducing agent injectors have been described as injecting droplets of liquid reducing agent into the exhaust gas stream, it would understood by a person skilled in the art that the reducing agent injectors may be designed such that the liquid reducing agent, in whole or in part, is vaporized as it travels through the injector such that the reducing agent is ejected from the injector into the exhaust gas stream, in whole or in part, in vapour form.

### Model Testing of GE LM6000 PC

In designing SCR systems, it is common in the industry to perform reduced scale model studies using modelling theories known to a person skilled in the art to predict if a system design will work in a full-size installation. These model studies can be built and tested at a fraction of the cost of building and testing a full-size installation. The methodology adopted for the modeling study as set out below is commonly used and accepted in the industry. Modeling studies conducted with similar methodologies on an SCR catalyst system with a conventional reducing agent injection grid upstream of the catalyst bed typically have resulted in % RMS distributions of the reducing agent at the catalyst bed in the range of approx. 9.5-13%.

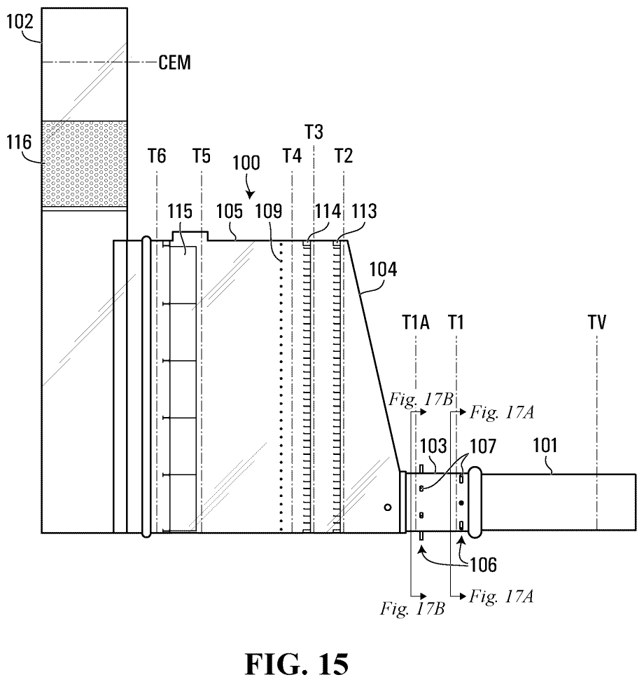

A ⅛ scale model study was conducted of a GE LM6000 PC gas turbine exhaust outlet connected to an SCR catalyst system with a direct reducing agent injection system in accordance with an embodiment of this invention. FIGS. 15 to 18 show the general configuration of the system that was the basis for the model study.

The design criteria for the model were to have an ammonia slip being no greater than 5 ppm and the NOx removal being no less than 90%. Based upon the design of the SCR catalyst system, these criteria required a distribution of the reducing agent at the inlet of the catalyst bed of no greater than 10% RMS under full load conditions. However, as would be understood by a person skilled in the art, different design criteria could be implemented for the SCR catalyst system which could result in a higher or lower target % RMS distribution.

### (a) Model Design

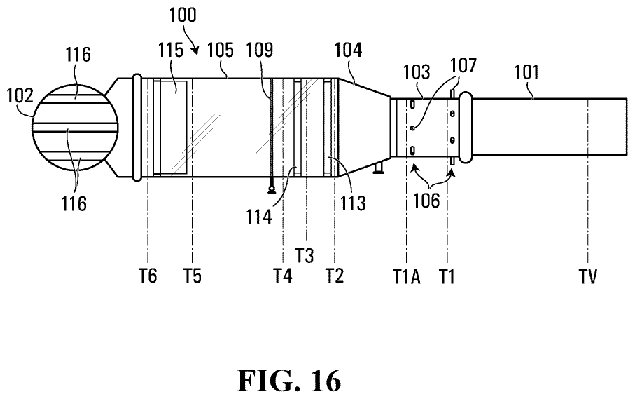

The ⅛ model for the study was constructed of plexiglass. As shown in FIG. 15 and FIG. 16, the SCR catalyst system comprised a duct system 100 connected between a turbine exhaust outlet 101 and a stack 102. The duct system 100 comprises an inlet duct 103, an expansion duct 104 downstream of the inlet duct and a horizontal duct 105 downstream of the expansion duct.

The turbine exhaust outlet 101 was designed to simulate the exhaust gas outlet of a GE LM6000 PC gas turbine based upon the specifications for that turbine. To simulate the exhaust gas flow from the turbine, air in the turbine exhaust outlet 101 was supplied by a centrifugal fan driven by a 30 hp motor. The air supplied to the model was at ambient temperature at approximately 75° F.

The inlet duct 103 included a reducing agent direct injection system 106 comprising two series of injectors 107. As discussed in greater detail below, for the model testing, a tracer gas, namely carbon monoxide, was injected through the injectors 107 to simulate the injection of the liquid reducing agent. Air was also injected with the carbon monoxide to simulate the injection of gas through the nozzle of the injectors 29 and 30 in a full-size installation. The injectors 107 included a nozzle at the end designed to spray the mixture of air and tracer gas into the exhaust gas stream flow in a manner that replicated the injection of a liquid reducing agent in a full-size installation. The flow rate of the CO and air being injected through the injectors 107 was controlled with flow meters and pressure gauges and was injected at the appropriate rate in accordance with the momentum flux ratio calculations discussed in greater detail below. Given that the temperature of the exhaust gas turbines outlet in a full-size installation is significantly greater than the boiling points of the liquid reducing agent, the liquid reducing agent is vaporized immediately. As such, the injection for a tracer gas and compressed air in the model at the same momentum flux ratio as the injected liquid reducing agent (which was 19% aqueous ammonia) and compressed air to exhaust gas stream in the full-size installation simulates the injection liquid reducing agent in the full-size installation. As discussed below, the tracer gas concentration was measured across the cross-section of the horizontal duct 105 at the inlet of the catalyst bed simulator to assess the reducing agent distribution at that location in the full-size installation.

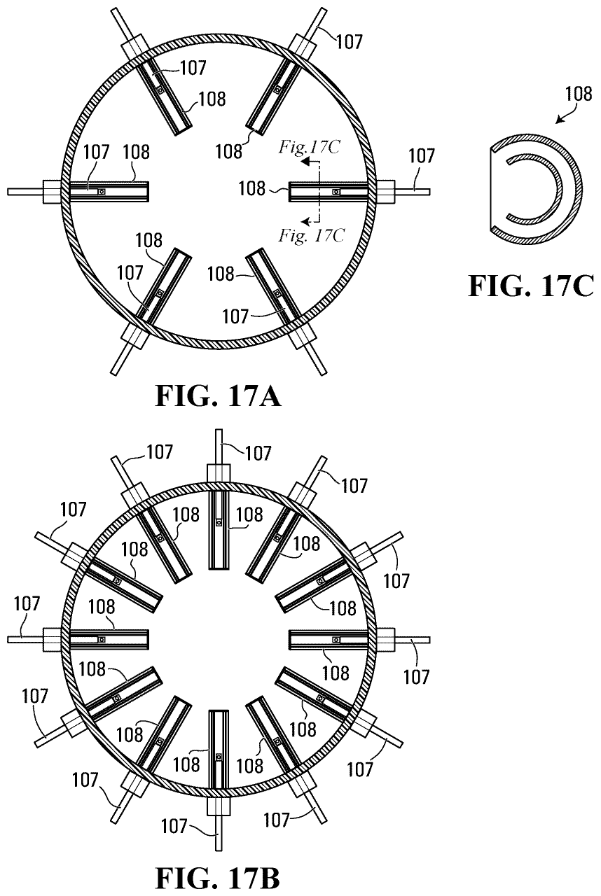

As shown in FIG. 17A & FIG. 17B, the two series of injectors 107 each comprised 6 injectors spaced 60° apart. The two series of injectors are rotated 30° relative to each other. A corresponding injector sleeve 108 was positioned around each of the injectors 107. A cross-sectional view of the injector sleeves 108 is shown in FIG. 17C. The injector sleeves 108 were designed to replicate the injector sleeves 33 in the full-size installation discussed above.

Each of the injectors 107 in the model were designed to move radially within the inlet duct 103 to allow for the positioning of its nozzle at different radial locations within the inlet duct 103. For the purpose of the model testing, each of the injectors 107 used in the tests (discussed in greater detail below) were inserted such that the nozzle was positioned approximately halfway along the corresponding injector sleeve 108 as generally shown in FIGS. 17A and 17B.

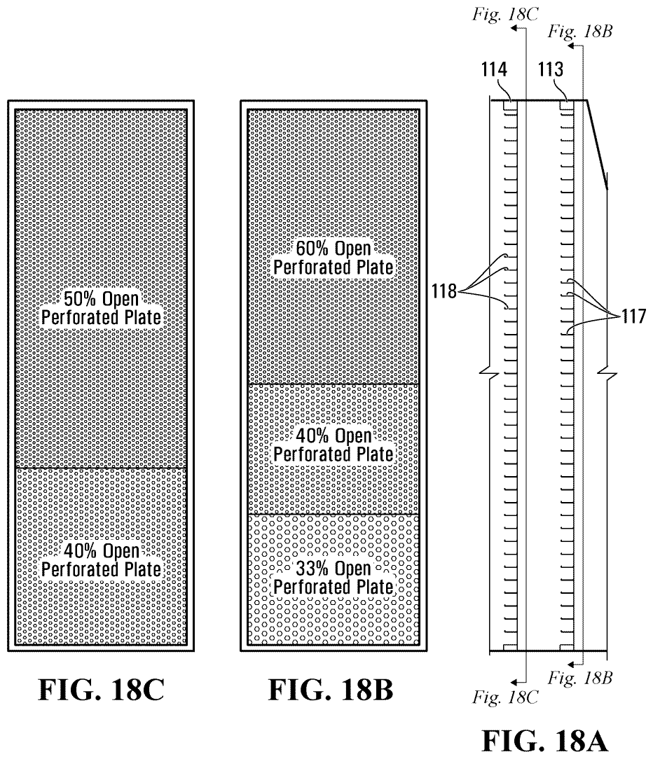

As shown in FIG. 15 and FIG. 18A to C, the horizontal duct 105 includes a first and second flow distribution grid 113 and 114 comprised of perforated metal plates with ¼″ holes. The flow of the exhaust gas stream though each of the flow distribution grids 113 and 114 can be varied by blocking certain holes in the distribution grids with tape which results in the exhaust gas stream only traveling through the unblocked holes. As such, the flow through each of the distribution grids can be varied to obtain a desired velocity profile downstream of the distribution grids. Both of the first and second flow distribution grids 113 and 114 included conventional flow straighteners 117 and 118 attached on the downstream side in a manner that would be understood by a person skilled in the art.

A reducing agent injection grid simulator 109 was also positioned in the horizontal duct 105. The reducing agent injection grid simulator 109 was made of wooden dowels and sheet metal but was not operational. The reducing agent injection grid simulator 109 was included in the model as a conventional reducing agent injection grid was to be included in the full-size installation for the purpose of the full-size testing discussed below and as such, the reducing agent injection grid simulator 109 was included to simulate the pressure loss that would occur across the conventional reducing agent injection grid in the full-size installation.

The horizontal duct 105 also includes a catalyst bed simulator 115 made of sheets of perforated metal plate and eggcrate flow straighteners designed to simulate the pressure loss as the exhaust gas stream flows through the catalyst bed in the full-size installation.

In operation, the exhaust gas stream exiting the turbine exhaust outlet 101 passes into the inlet duct 103 through direct reducing agent injection system 106 before entering the expansion duct 104. The exhaust gas stream exiting the expansion duct 104 enters the horizontal duct 105 and passes through the first and second flow distribution grids 113 and 114, the reducing agent injection grid simulator 109 and the catalyst bed simulator 115. After passing through the catalyst bed simulator 115, the exhaust gas stream exits through the stack 102. As shown in FIG. 15 and FIG. 16, the stack 102 includes three silencer panels 116 made of plywood and skinned with perforated plate to simulate the rough outer surface of silencer panels used in the stack of a full-size installation.

The swirl angles of the exhaust flow leaving the turbine exhaust outlet 101 could be varied between 20° clockwise and 20° counterclockwise to cover a range of load conditions based upon known flow patterns of exhaust gas streams at the outlet of gas turbines. In particular, it is generally understood that an exhaust gas steam at the outlet of a gas turbine operating under a full load condition can be represented by a swirl angle of approximately 20° clockwise and an exhaust gas steam at the outlet of a gas turbine operating under a low load condition can be represented by a swirl angle of approximately 20° counterclockwise.

### (b) Test Locations

A number of different test locations were used in the model study which are shown in FIG. 15 and FIG. 16 and described in Table 2-1 below.

TABLE 2-1

| Test Location | Description |
|---|---|
| TV | Control Volume |
| T1 | Turbine Exhaust Gas Inlet Duct |
| T2 | First Flow Distribution Grid Inlet |
| T3 | Second Flow Distribution Grid Inlet |
| T4 | Conventional Reducing Agent Injection Grid Inlet |
| T5 | Catalyst Bed Simulator Inlet |
| T6 | Catalyst Bed Simulator Outlet |
| CEM | Stack Continuous Emission Monitoring System |

These test locations were selected at strategic locations to measure the incremental velocity and pressure losses throughout the entire system and tracer gas concentrations to allow for the analysis discussed in greater detail below to be completed.

### (c) Flow Conditions

The model testing was conducted based upon the flow conditions for the GE LM6000 PC gas turbine in full load operation which generates the highest outlet volume flow. These flow conditions were selected as they present the shortest exhaust gas stream residence time within the catalyst bed as well as the highest pressure drop across the duct system given that the exhaust gas stream velocities are the highest. These flow conditions selected are as follows:

$$\begin{matrix}Full - size Turbine Exhaust Conditions : \\ \begin{matrix}{M}_{Full - size} = 1 , 110 , 348 lb / hr \\ {Q}_{Full - size} = 589 , 067 acfm \\ {T}_{Full - size} = 794 ° F \\ {ρ}_{Full - size} = 0.0314 lb / {ft}^{3}\end{matrix}\end{matrix}$$

$$\begin{matrix}Full - size Reducing Agent Conditions : \\ {M}_{Full - size} = 100 lb / hr - ( 19 \% aqueous ammonia )\end{matrix}$$

Where:
   M is the mass flow;
   Q is the flow rate in actual cubic feet per minute;
   T is temperature; and
   ρ is gas density.

### (d) Scaling Parameters and Similitude

This model study was conducted using a geometric linear scale factor of ⅛. As a result, the dimensions and cross-sectional area at each of the testing locations were as shown in Table 2-2 below:

TABLE 2-2

| | Full-size | | Model | |
|---|---|---|---|---|
| Location | Dimension (ft) | Area (ft²) | Dimension (ft) | Area (ft²) |
| TV | Dia = 5.08 | 20.29 | Dia = 0.636 | 0.32 |
| TI | Dia = 6.74 | 35.78 | Dia = 0.842 | 0.56 |
| T2 | 11 × 30.67 | 337.33 | 1.375 × 3.83 | 5.27 |
| T3 to T6 | 11.5 × 34.17 | 392.92 | 1.438 × 4.27 | 6.14 |
| CEM | Dia = 11.67 | 106.90 | Dia = 1.46 | 1.67 |

The duct system at Locations TV, T1 and CEM have a circular cross-section with “Dia” being the diameter. The duct system at the remainder of the locations has a rectangular cross-section with width by height measurements shown above.

The model study also had an approximate velocity scale of 1/3.33. The velocity scale was based upon a maximum flow rate for the fan used to supply the exhaust gas stream air in the model. As a result, the velocity of the exhaust gas stream at the inlet duct (Location T1 in FIG. 15) in the model was 82 ft/s as compared to 274 ft/s in the full-size installation at the flow conditions set out above.

Also, a comparison between the flow conditions at the inlet of the catalyst bed/catalyst bed simulator inlet (Location T5 in FIG. 15) for a GE LM6000 PC gas turbine at full-load operation in a full-size installation and the model are shown in Table 2-3 below:

TABLE 2-3

| | | |
|---|---|---|
| Flow Conditions at T5 | Full-size | Model |

| | | | | |
|---|---|---|---|---|
| Mass Flow | 1,110,348 | lb/hr | 12,243 | lb/hr |
| Flow Rate | 589,067 | acfm | 2,761 | acfm |
| Area | 392.92 | ft² | 6.14 | ft² |
| Velocity (Flow rate / Area) | 1,499 | fpm | 450 | fpm |
| Gas Temperature | 794° | F. | 75° | F. |
| Gas Density | 0.0314 | lb/ft³ | 0.0739 | lb/ft³ |

In gas flow modeling, it is theoretically desirable to simultaneously maintain geometric, kinematic and dynamic similarity. However, such a condition is not possible when using scale models. As such, the scaling factors were chosen using the following rationale in considering these criteria.

When a sufficiently large geometric scaling factor is used the most critical aspect of geometric similarity is satisfied and the reliability of measurements can be obtained. A linear scale of ⅛ was determined to be sufficient to satisfy this criterion and yet be economical to build and test.

Kinematic similarity is dependent upon the Reynolds Number (Re) and has no significant influence on the results if the Reynolds Number is maintained above the minimum value to ensure fully turbulent flow conditions, namely above approximately 20,000 (i.e., the minimum Re to ensure fully turbulent flow conditions). Based on the mean velocity at the catalyst bed inlet/catalyst bed simulator inlet, the Reynolds Numbers for the full-size installation and the model were calculated to be 6.09×10⁵ and 9.60×10⁴ respectively as shown below, thus satisfying the above criteria.

$$Reynolds Number ( Re ) = \frac{VD}{v}$$

Where: V=velocity
   D=characteristic length
   ν=kinematic viscosity of fluid

### Calculation of Re for Full-Size Installation

$$\begin{matrix}V = 1499 / 60 = 25 ft / s \\ D = 2 ab / ( a + b ) for a rectangular duct where a = width and b = height \\ = 2 \times 11.5 \times 34.17 / ( 11.5 + 34.17 ) \\ = 17.21 feet \\ v = 7.06 \times {10}^{- 4} {ft}^{2} / s at 794 ° F . \\ {Re}_{Full - size} = \frac{VD}{v} = 6.09 \times {10}^{5}\end{matrix}$$

### Calculation of Re for Model

$$\begin{matrix}V = 450 / 60 = 7.5 ft / s \\ D = 2 ab / ( a + b ) for a rectangular duct where a = width and b = height \\ = 2 \times 1.438 \times 4.27 / ( 1.438 + 4.27 ) \\ = 2.15 feet \\ v = 1.68 \times {10}^{- 4} {ft}^{2} / s at 75 ° F . \\ {Re}_{Model} = \frac{VD}{v} = 9.6 \times {10}^{4}\end{matrix}$$

As fully turbulent flow conditions were maintained in the model study, the pressure losses can be measured in the model and predictions made for the full-size installation using the scaling formulae shown below, which is a form of Bernoulli's equation (where P is pressure, V is velocity and ρ is gas density).

$${P}_{Full - size} = {P}_{Model} \times {( \frac{{V}_{Full - size}}{{V}_{Model}} )}^{2} \times \frac{{ρ}_{{Gas}_{Full - size}}}{{ρ}_{{Air}_{Model}}}$$

This particular model study used air of uniform air density for the exhaust gas stream. The small size of the model makes the forces of gravity negligible in comparison with the inertia forces created by the momentum of the exhaust gas stream air. Therefore, dynamic similarity was not essential to maintain.

As discussed above, carbon monoxide was used as the tracer gas injected with compressed air through the injectors. For similarity, the momentum flux ratio between the CO/compressed air mixture with the exhaust gas stream flow in the inlet duct (Location T1 in FIG. 15) in the model was set equal to the momentum flux ratio between the reducing agent (NH₃)/atomizing air mixture with the exhaust gas stream flow in the inlet duct (Location T1 in FIG. 15) of the full-size installation as shown in Table 2-4 below:

TABLE 2-4

| | Units | Full-size | Model |
|---|---|---|---|
| Inlet Duct (T1): | | | |
| Mass Flow | lb/hr | 1,110,348 | 12,243.39 |
| Volume Flow | acfm | 589,067 | 2,761.25 |
| Gas Temp | deg F. | 794 | 75 |
| Gas Density | lb/ft³ | 0.0314 | 0.0739 |
| Duct Area | ft² | 35.78 | 0.559 |
| Duct Velocity | ft/s | 274.36 | 82.307 |
| Momentum Flux | lb*ft/s² | 84,620 | 279.922 |
| Direct Injection: | | | |
| Mass Flow | lb/hr | 100 | 1.483 |
| Volume Flow | acfm | 37.45 | 0.334 |
| Gas Temp | deg F. | 120 | 75 |
| Gas Density | lb/ft³ | 0.0445 | 0.0739 |
| Mouth Velocity | ft/s | 670 | 149.485 |
| Momentum Flux | lb*ft/s² | 18.6111 | 0.061566 |

| | | |
|---|---|---|
| Momentum Flux Ratio: | 4547 | 4547 |

### (f) Test Results

Traverse testing methodology was used to measure the velocity distribution and distribution of CO at the inlet of the catalyst bed simulator as discussed in greater detail below. In particular, measurements were taken at 40 points across the inlet cross-sectional area of the catalyst bed simulator. A map of the points looking downstream at the catalyst bed simulator is shown below:

TABLE 2-5

| | A | B | C | D | E |
|---|---|---|---|---|---|
| 8 (Top) | | | | | |
| 7 | | | | | |
| 6 | | | | | |
| 5 | | | | | |
| 4 | | | | | |
| 3 | | | | | |
| 2 | | | | | |
| 1 (Bottom) | | | | | |

Based upon the measurements at each of the traverse points, the % RMS was calculated as set out above.

### (i) Velocity Distributions & Pressure Loss

The model was first tested to evaluate the velocity distribution at the conventional reducing agent injection grid inlet (Location T4 in FIG. 15), which will be essentially identical to the velocity distribution at the catalyst bed simulator inlet (Location T5 in FIG. 15). With both flow distribution grids having a baseline porosity of 50% open, the velocity distribution at the conventional reducing agent injection grid inlet (Location T4 in FIG. 15) was non-uniform. Modifications were made to the porosity of the flow distribution grids through an iterative process until a target velocity distribution with an RMS deviation of less than 15% was achieved at the catalyst bed simulator inlet.

The iterative process referenced above resulted in an arrangement in the porosity of the flow distribution grids as shown in FIG. 18B and FIG. 18C. The velocity distribution at the conventional reducing agent injection grid inlet (Location T4 in FIG. 15) was measured with the flow distribution grids configured as shown in FIG. 18B and FIG. 18C for the two turbine outlet swirls. Both distributions were acceptable with % RMS less than 14.8% (which was within the target criteria of less than 15%) as shown in Table 2-6 below:

TABLE 2-6
20° CW SWIRL

| | | | | | | Row |
|---|---|---|---|---|---|---|
| | A | B | C | D | E | Averages |
| 8 | 102 | 102 | 108 | 106 | 107 | 105 |
| 7 | 107 | 108 | 115 | 111 | 115 | 111 |
| 6 | 106 | 93 | 93 | 98 | 109 | 100 |
| 5 | 101 | 89 | 94 | 98 | 92 | 95 |
| 4 | 84 | 86 | 97 | 78 | 92 | 87 |
| 3 | 104 | 83 | 87 | 84 | 75 | 87 |
| 2 | 128 | 106 | 106 | 82 | 89 | 102 |
| 1 | 148 | 125 | 115 | 86 | 94 | 114 |
| Column | 110 | 99 | 102 | 93 | 97 | |
| Averages | | | | | | |

% RMS = 14.4% of the mean velocity

20° CCW SWIRL

| | | | | | | Row |
|---|---|---|---|---|---|---|
| | A | B | C | D | E | Averages |
| 8 | 109 | 107 | 105 | 113 | 117 | 110 |
| 7 | 116 | 105 | 111 | 106 | 103 | 108 |
| 6 | 99 | 90 | 83 | 96 | 88 | 91 |
| 5 | 89 | 86 | 96 | 88 | 94 | 90 |
| 4 | 83 | 81 | 90 | 80 | 98 | 86 |
| 3 | 98 | 81 | 89 | 76 | 81 | 85 |
| 2 | 119 | 101 | 117 | 99 | 123 | 112 |
| 1 | 129 | 96 | 104 | 111 | 143 | 117 |
| Column | 105 | 93 | 99 | 96 | 106 | |
| Averages | | | | | | |

% RMS = 14.8% of the mean velocity

The estimated static pressure loss from the turbine outlet to atmosphere with the flow distribution grids installed as shown in shown in FIG. 18B and FIG. 18C was calculated to be 9.84 inches of water column static pressure. This pressure loss across the system was well within the acceptable range of below 12 inches of water column of static pressure. This pressure loss assumed design pressure loss across the SCR catalyst and did not include stack draft.

### (ii) Direct Reducing Agent Injection

As referenced above, the direct reducing agent injection was tested by injecting a tracer gas, namely carbon monoxide gas along with air through the simulated reducing agent injectors. The flowrate of the mixture of carbon monoxide and air used in the model was based on the momentum flux ratio calculations set out above.

The distribution of the carbon monoxide gas was then measured at the catalyst bed simulator inlet (Location T5 in FIG. 15) using a multi-gas sampler with a sampling probe that had an accuracy of +/−1%. Sufficient carbon monoxide was included in the mixture to be detected by this device.

Three different injector arrangements were tested, namely:
Test #1: A three injector arrangement was used comprising of the injectors at the 1 o'clock, 5 o'clock and 9 o'clock positions as shown in FIGS. 17A and 17B;
Test #2: A four injector arrangement was used comprising of the injectors at the 1 o'clock, 3 o'clock, 7 o'clock and 9 o'clock positions as shown in FIGS. 17A and 17B; and
Test #3: A three injector arrangement was used comprising of the injectors at the 3 o'clock, 7 o'clock and 11 o'clock positions as shown in FIGS. 17A and 17B.

The distribution of the carbon monoxide gas at the catalyst bed simulator inlet (Location T5 in FIG. 15) with the three injector Test #1 arrangement for each of the turbine swirls are shown in Table 2-7 below:

TABLE 2-7
20° CW SWIRL
Concentrations (PPM)

| | A | B | C | D | E |
|---|---|---|---|---|---|
| 8 | 115 | 116 | 118 | 119 | 119 |
| 7 | 117 | 119 | 120 | 121 | 121 |
| 6 | 116 | 118 | 120 | 122 | 122 |
| 5 | 113 | 115 | 120 | 122 | 123 |
| 4 | 116 | 119 | 125 | 126 | 125 |
| 3 | 126 | 125 | 133 | 139 | 141 |
| 2 | 149 | 148 | 132 | 132 | 136 |
| 1 | 146 | 142 | 136 | 137 | 133 |

Mean Concentration = 126 PPM
% RMS = 7.8% of Mean Concentration
20° CCW SWIRL

Concentrations (PPM)

| | A | B | C | D | E |
|---|---|---|---|---|---|
| 8 | 122 | 123 | 123 | 122 | 122 |
| 7 | 123 | 124 | 124 | 124 | 123 |
| 6 | 123 | 124 | 126 | 126 | 124 |
| 5 | 123 | 124 | 127 | 128 | 125 |
| 4 | 146 | 131 | 126 | 126 | 122 |
| 3 | 148 | 129 | 123 | 120 | 116 |
| 2 | 137 | 123 | 118 | 116 | 116 |
| 1 | 147 | 142 | 137 | 123 | 112 |

Mean Concentration = 126 PPM
% RMS = 6.4% of Mean Concentration

The distribution of the carbon monoxide gas at the catalyst bed simulator inlet (Location T5 in FIG. 15) with the four injector Test #2 arrangement for each of the turbine swirls are shown in Table 2-8 below:

TABLE 2-8
20° CW SWIRL
Concentrations (PPM)

| | A | B | C | D | E |
|---|---|---|---|---|---|
| 8 | 117 | 118 | 119 | 119 | 118 |
| 7 | 119 | 120 | 120 | 120 | 118 |
| 6 | 120 | 121 | 120 | 119 | 118 |
| 5 | 119 | 119 | 120 | 120 | 119 |
| 4 | 128 | 119 | 118 | 115 | 117 |
| 3 | 146 | 124 | 119 | 117 | 112 |
| 2 | 145 | 141 | 143 | 143 | 129 |
| 1 | 144 | 123 | 114 | 120 | 107 |

Mean Concentration = 123 PPM
% RMS = 7.7% of Mean Concentration
20° CCW SWIRL

Concentrations (PPM)

| | A | B | C | D | E |
|---|---|---|---|---|---|
| 8 | 111 | 113 | 116 | 119 | 118 |
| 7 | 108 | 112 | 116 | 118 | 118 |
| 6 | 108 | 112 | 117 | 118 | 118 |
| 5 | 104 | 107 | 115 | 120 | 122 |
| 4 | 106 | 97 | 106 | 118 | 120 |
| 3 | 109 | 109 | 107 | 108 | 104 |
| 2 | 113 | 103 | 99 | 98 | 87 |
| 1 | 117 | 117 | 116 | 113 | 96 |

Mean Concentration = 111 PPM
% RMS = 7.0% of Mean Concentration

The distribution of the carbon monoxide gas at the catalyst bed simulator inlet (Location T5 in FIG. 15) with the three injector Test #3 arrangement for each of the turbine swirls are shown in Table 2-9 below:

TABLE 2-9
20° CW SWIRL
Concentrations (PPM)

| | A | B | C | D | E |
|---|---|---|---|---|---|
| 8 | 118 | 118 | 118 | 119 | 118 |
| 7 | 120 | 121 | 122 | 121 | 120 |
| 6 | 121 | 122 | 122 | 122 | 121 |
| 5 | 120 | 121 | 122 | 122 | 121 |
| 4 | 122 | 119 | 119 | 122 | 120 |
| 3 | 120 | 119 | 117 | 119 | 139 |
| 2 | 115 | 121 | 122 | 126 | 135 |
| 1 | 115 | 143 | 157 | 148 | 166 |

Mean Concentration = 124 PPM
% RMS = 8.8% of Mean Concentration
20° CCW SWIRL

Concentrations (PPM)

| | A | B | C | D | E |
|---|---|---|---|---|---|
| 8 | 125 | 120 | 116 | 114 | 111 |
| 7 | 130 | 127 | 123 | 123 | 117 |
| 6 | 134 | 131 | 124 | 120 | 116 |
| 5 | 138 | 137 | 130 | 121 | 117 |
| 4 | 119 | 135 | 139 | 126 | 118 |
| 3 | 121 | 129 | 122 | 119 | 115 |
| 2 | 123 | 121 | 117 | 116 | 106 |
| 1 | 108 | 112 | 113 | 117 | 110 |

Mean Concentration = 122 PPM
% RMS = 6.7% of Mean Concentration

As shown above, the 20° clockwise turbine outlet swirl for each of the three injector arrangements had an % RMS deviation below the design criteria of no greater than 10% at full load operation. As referenced above, this was achieved with the velocity of the exhaust gas stream at the inlet duct (Location T1 in FIG. 15) being 82 ft/s. These distributions were also below the typical range of 9.5-13% obtained in model testing of SCR catalyst systems with conventional reducing agent injection grids upstream of the catalyst bed.

In addition, the 20° counterclockwise turbine outlet swirl for each of the three injector arrangements had an % RMS deviation below the design criteria of no greater than 10% at full load operation.

### Full-Size Installation Testing of GE LM6000 PC

Testing was conducted on a full-size GE LM6000 PC gas turbine system to compare the performance of certain configurations of a direct reducing agent injection system in accordance with the first embodiment of the invention described above (as shown in FIGS. 4 to 11) as compared to that of a conventional reducing agent injection grid. The design conditions of the system are as follows:

TABLE 3-1
SCR System Design Conditions

| | | |
|---|---|---|
| Turbine Fuel Flow (Maximum) | SCFM | 7,600 |
| Ammonia Grade | | 19% |
| SCR Catalyst Volume | ft³ | 440 |
| Design Inlet NOx Concentration | ppmvdc | 25 |
| Design Stack NOx | ppmvdc | 2.5 |
| Stack NOx Set-Point | ppmvdc | 2.0 |
| Design NOx Conversion Requirement | % | 90% |
| Ammonia Slip Limit | ppmvdc | 5 |

The duct system used for the testing incorporated a combined CO and NOx catalyst bed. As referenced above, the catalyst bed was designed to, at full load operation, reduce the NOx levels from 25 ppmvdc to 2.5 ppmvdc (“parts per million volume dry corrected”), namely a 90% reduction, while maintaining the reducing agent slip below 5 ppmvdc. The reducing agent used for the testing was 19% aqueous ammonia.

The duct system was equipped with two alternative reducing agent injection systems. First, a conventional reducing agent injection grid is positioned upstream of the catalyst bed. Second, a reducing agent direct injection system of the type shown in FIGS. 4 to 11 and described above was provided in the inlet duct downstream of the turbine exhaust gas stream exit. An ammonia flow control unit (AFCU) provided the ability to switch the reducing agent flow from the conventional reducing agent injection grid to the reducing agent direct injection system. When operating in the conventional reducing agent injection grid mode, a blower recirculated hot exhaust gas from the duct system to vaporize the reducing agent prior to injection through the conventional injection grid. When operating the direct reducing agent injection system mode, aqueous ammonia was circulated through reducing agent supply tube 54 for injection into the injectors through the reducing agent lines 50. In addition, instrument air was circulated through the gas supply tube 55 for injection into the injectors through gas lines 49. Finally, cooling air was circulated through the coolant supply line 56 for injection into each of the coolant ports 45 of the external injector assemblies 32 through the coolant lines 51.

Traverse testing methodology was used to measure the distribution of the NOx and ammonia at the inlet of the catalyst bed to determine the effectiveness of the distribution of the reducing agent at the inlet of the catalyst bed. In particular, measurements were taken at 28 points across the exit cross-section area of the catalyst bed. A map of the points looking downstream at the catalyst bed is shown below:

TABLE 3-2
Traverse Map

Points

| | A | B | C | D |
|---|---|---|---|---|
| 7 (Top) | | | | |
| 6 | | | | |
| 5 | | | | |
| 4 | | | | |
| 3 | | | | |
| 2 | | | | |
| 1 (Bottom) | | | | |

NOx (NO and NO₂) and ammonia levels were measure at each of the 28 points.

Based upon the measurements at each of the traverse points, the % RMS was calculated as set out above with:

$${M}_{i} = \frac{{NH}_{3}}{{NO}_{x}} ratio at inlet of the catalyst bed for each traverse point$$

$$\overline{M} = mean \frac{{NH}_{3}}{{NO}_{x}} ratio at inlet of the catalyst bed$$

Sample measurements of the NOx at the inlet of the catalyst bed were compared to measurements of the inlet NOx measured by the CEMS (Continuous Emissions Monitoring System) and the measurements were found to be the same. This allowed the CEMS Inlet NOx to be used to calculate

$$\frac{{NH}_{3}}{{NO}_{x}}$$

ratio at the inlet of the catalyst bed for each traverse point as follows:

$$\frac{{NH}_{3}}{{NO}_{x}} = \frac{( ( CEMS Inlet {NO}_{x} - Measured Exit {NO}_{x} ) + Measured Exit {NH}_{3} )}{CEMS Inlet {NO}_{x}}$$

CEMS Inlet NOₓ=CEMS measured inlet NOₓ (ppmvdc) corrected to 15% oxygen.
Measured Exit NOₓ=Measured NOₓ (ppmvdc) at the exit of the catalyst bed at each traverse point corrected to 15% oxygen.
Measured Exit NH₃=Measured NH₃ (ppmvdc) at the exit of the catalyst bed at each traverse point corrected to 15% oxygen.
   These calculations are based upon the assumptions that the inlet NOx and exhaust flow was uniform at each traverse point, which was confirmed by spot checks.

### (i) Full Load Testing

The first set of tests were run with the GE LM6000 PC operating at full load, namely at approx. 47 MW. At full load the exhaust gas stream entering the inlet duct has a velocity in the range of approx. 239-275 ft/s and a temperature in the range of approx. 793-861° F.

As a baseline test, the system was operated injecting the reducing agent using the conventional reducing agent injection grid. The NOx and ammonia profiles for the conventional reducing agent injection grid at the NOx catalyst exit, across the 28 traverse points are reproduced below:

TABLE 4-1
NOx Profile (ppmvdc) - Conventional
Injection Grid - Baseline (Full Load)

| Port | A | B | C | D |
|---|---|---|---|---|
| 7 | 2.6 | 3.5 | 3.0 | 3.3 |
| 6 | 2.6 | 3.0 | 3.1 | 2.4 |
| 5 | 2.1 | 2.9 | 2.8 | 2.1 |
| 4 | 1.7 | 2.0 | 1.9 | 2.3 |
| 3 | 1.4 | 1.6 | 1.5 | 1.6 |
| 2 | 1.3 | 1.4 | 1.6 | 1.6 |
| 1 | 1.3 | 1.4 | 1.4 | 1.0 |

TABLE 4-2
Ammonia Profile (ppmvdc) - Conventional
Injection Grid - Baseline (Full Load)

| Port | A | B | C | D |
|---|---|---|---|---|
| 7 | 1.6 | 1.4 | 0.6 | 1.1 |
| 6 | 1.3 | 1.3 | 1.3 | 1.1 |
| 5 | 1.8 | 1.3 | 1.5 | 1.1 |
| 4 | 2.2 | 2.1 | 1.7 | 1.7 |
| 3 | 2.8 | 2.9 | 1.5 | 2.3 |
| 2 | 2.5 | 2.8 | 2.8 | 3.3 |
| 1 | 2.3 | 2.5 | 2.8 | 3.0 |

For the conventional injection grid, the baseline average duct NOx concentration leaving the catalyst bed was 2.1 ppmvdc and the baseline average ammonia leaving the catalyst bed was 1.94 ppmvdc. As shown above, higher NOx and lower reducing agent slip was found at the top of the duct, while lower NOx and higher reducing agent slip was measured at the bottom of the duct. The baseline conventional grid ammonia-to-NOx % RMS at the inlet of the catalyst was calculated at 7.1%.

A further traverse test was performed where the control valves of the conventional injection grid were adjusted (“tuned”) to improve distribution of ammonia at the inlet of the catalyst bed. The NOx and ammonia profiles for the tuned conventional reducing agent injection grid at the NOx catalyst exit, across the 28 points are shown below:

TABLE 5-1
NOx Profile (ppmvdc) - Conventional
Injection Grid - Tuned (Full Load)

| Port | A | B | C | D |
|---|---|---|---|---|
| 7 | 1.7 | 2.9 | 1.8 | 2.2 |
| 6 | 3.0 | 3.0 | 2.5 | 2.1 |
| 5 | 3.1 | 2.5 | 2.2 | 2.7 |
| 4 | 1.2 | 1.8 | 2.2 | 1.9 |
| 3 | 1.4 | 1.6 | 1.7 | 1.3 |
| 2 | 1.2 | 1.4 | 1.8 | 1.0 |
| 1 | 1.4 | 1.5 | 1.2 | 1.3 |

TABLE 5-2
Ammonia Profile (ppmvdc) - Conventional
Injection Grid - Tuned (Full Load)

| Port | A | B | C | D |
|---|---|---|---|---|
| 7 | 1.5 | 1.8 | 1.3 | 1.2 |
| 6 | 1.3 | 1.6 | 1.3 | 1.6 |
| 5 | 0.7 | 1.7 | 2.0 | 2.4 |
| 4 | 1.1 | 2.7 | 2.0 | 0.7 |
| 3 | 0.9 | 2.8 | 2.8 | 2.1 |
| 2 | 2.1 | 3.0 | 2.0 | 1.8 |
| 1 | 1.7 | 2.3 | 3.0 | 2.9 |

The average duct NOx concentration leaving the catalyst bed was 1.9 ppmvdc and the average ammonia concentration leaving the catalyst bed was 1.9 ppmvdc for the tuned conventional grid. The conventional grid tuning improved the ammonia distribution by reducing the high ammonia slip at the bottom of the duct and high NOx at the top of the duct. The final ammonia-to-NOx % RMS for the conventional grid at the inlet of the catalyst bed was 5.8%, which was a reduction of 1.3% from the baseline test discussed above.

The AFCU was then switched over to use the reducing agent direct injection system. As discussed below, several different configurations were tested.

The first configuration comprised using three of the injectors 29 positioned in the 1, 5 and 9 o'clock positions as shown in FIG. 5. The flow valves 52, 53 and 57 for each of these injectors were turned to a fully open position. In addition, the reducing agent metering valve 63 for each of these injectors was placed in a fully open position. All of the flow valves 52, 53 and 57 for the other injectors 29 and 30 not in used were turned to the close position. Each of the injectors 29 in use were fully inserted in the external injection assemblies 32.

The NOx and ammonia profiles for this first configuration of the direct injection system at the NOx catalyst exit are shown below:

TABLE 6-1
NOx Profile (ppmvdc) - Direct Injection
System - Config. 1 (Full Load)

| Port | A | B | C | D |
|---|---|---|---|---|
| 7 | 4.4 | 5.0 | 5.0 | 4.4 |
| 6 | 3.4 | 4.7 | 4.7 | 3.3 |
| 5 | 2.1 | 3.5 | 3.6 | 2.2 |
| 4 | 1.8 | 1.8 | 1.4 | 1.4 |
| 3 | 1.2 | 1.4 | 1.3 | 1.1 |
| 2 | 1.2 | 1.1 | 1.3 | 1.2 |
| 1 | 1.0 | 1.1 | 1.1 | 1.1 |

TABLE 6-2
Ammonia Profile (ppmvdc) - Direct Injection
System - Config. 1 (Full Load)

| Port | A | B | C | D |
|---|---|---|---|---|
| 7 | 1.2 | 1.2 | 0.8 | 1.0 |
| 6 | 1.6 | 1.3 | 0.4 | 0.8 |
| 5 | 2.8 | 1.9 | 0.7 | 2.5 |
| 4 | 3.7 | 4.3 | 5.8 | 4.9 |
| 3 | 5.3 | 6.5 | 5.9 | 3.8 |
| 2 | 5.7 | 6.9 | 7.0 | 7.2 |
| 1 | 5.9 | 7.1 | 6.8 | 5.0 |

The average NOx concentration leaving the catalyst bed was 2.4 ppmvdc and the average ammonia concentration leaving the catalyst bed was 3.9 ppmvdc. Similar to the baseline conventional injection grid, higher NOx levels were measured at the top of the duct, and higher ammonia slip was measured at the bottom. For this first configuration of the direct injection system, the ammonia-to-NOx % RMS at the inlet of the catalyst was 17.8%.

For the second configuration of the direct injection system, the same three injectors 29 were used and the reducing agent metering valve 63 of each injector was maintained in the fully open position. However, each of the three injectors 29 were moved to a half-extended position such that the nozzles 34 of the injectors moved radially away from the center of the inlet duct 28. The NOx and ammonia profiles for this second configuration at the catalyst exit are shown below:

TABLE 7-1
NOx Profile (ppmvdc) - Direct Injection
System - Config. 2 (Full Load)

| Port | A | B | C | D |
|---|---|---|---|---|
| 7 | 2.3 | 2.1 | 2.1 | 2.0 |
| 6 | 2.3 | 2.2 | 1.4 | 1.9 |
| 5 | 2.2 | 2.0 | 2.4 | 2.1 |
| 4 | 2.3 | 2.0 | 2.6 | 2.5 |
| 3 | 2.5 | 2.0 | 2.2 | 3.2 |
| 2 | 2.5 | 1.3 | 1.5 | 3.2 |
| 1 | 1.0 | 1.3 | 1.2 | 1.0 |

TABLE 7-2
Ammonia Profile (ppmvdc) - Direct Injection
System - Config. 2 (Full Load)

| Port | A | B | C | D |
|---|---|---|---|---|
| 7 | 2.1 | 2.7 | 2.1 | 1.2 |
| 6 | 1.8 | 2.8 | 1.8 | 2.5 |
| 5 | 1.5 | 2.1 | 1.6 | 1.6 |
| 4 | 1.4 | 1.7 | 0.8 | 0.6 |
| 3 | 1.0 | 1.8 | 0.9 | 0.6 |
| 2 | 2.2 | 3.0 | 2.5 | 1.2 |
| 1 | 4.0 | 3.7 | 2.7 | 1.9 |

The average NOx concentration leaving the catalyst bed was 2.0 ppmvdc and the average ammonia concentration leaving the catalyst bed was 1.9 ppmvdc. This configuration provided good ammonia distribution across the exhaust gas stream and the performance was comparable to that of the conventional injection grid. For this second configuration of the direct injection system, the ammonia-to-NOx % RMS at the inlet of the catalyst was 5.3%, which was an improvement not only over the first configuration of the direct injection system but over both the baseline and tuned configurations of the conventional injection grid.

A third configuration of the direct injection system was also tested. In this configuration, the other three injectors 29 at the 3, 7 and 11 o'clock positions as shown in FIG. 5 were used and each of the injectors 29 was placed in a half-extended position. As such, the flow valves 52, 53 and 57 for each of these injectors were turned to the fully open position. In addition, the reducing agent metering valve 63 for each of these injectors was placed in the fully open position. All of the flow valves 52, 53 and 57 for the other injectors 29 and 30 not in use were turned to the close position.

The NOx and ammonia profiles for this third configuration of the direct reducing agent injection system at the catalyst exit are shown below:

TABLE 8-1
NOx Profile (ppmvdc) - Direct Injection
System - Config. 3 (Full Load)

| Port | A | B | C | D |
|---|---|---|---|---|
| 7 | 1.6 | 2.3 | 1.2 | 2.2 |
| 6 | 2.0 | 2.9 | 1.7 | 3.0 |
| 5 | 2.3 | 3.6 | 3.8 | 4.7 |
| 4 | 2.3 | 3.4 | 3.2 | 1.9 |
| 3 | 2.4 | 2.8 | 2.7 | 1.5 |
| 2 | 3.0 | 4.1 | 2.3 | 1.7 |
| 1 | 5.0 | 6.8 | 5.9 | 4.1 |

TABLE 8-2
Ammonia Profile (ppmvdc) - Direct Injection
System - Config. 3 (Full Load)

| Port | A | B | C | D |
|---|---|---|---|---|
| 7 | 7.1 | 5.3 | 5.3 | 5.0 |
| 6 | 4.4 | 3.1 | 2.3 | 2.0 |
| 5 | 2.5 | 1.2 | 0.6 | 1.1 |
| 4 | 2.1 | 1.1 | 0.6 | 1.1 |
| 3 | 2.2 | 1.7 | 0.2 | 2.0 |
| 2 | 2.3 | 1.1 | 1.5 | 1.1 |
| 1 | 0.1 | 0.1 | 0.3 | 0.6 |

The average NOx concentration leaving the catalyst bed was 3.0 ppmvdc and the average ammonia concentration leaving the catalyst bed was 2.1 ppmvdc. With this configuration, higher amounts of ammonia were dispersed towards the top of the duct, evidenced by higher ammonia slip at the top and higher NOx measured at the bottom. For the third configuration of the direct injection system, the ammonia-to-NOx % RMS at the inlet of the catalyst bed was 11.7%.

Finally, a fourth configuration of the direct injection system was tested. In this configuration, the four injectors 29 in the 1, 3, 7 and 9 o'clock positions as shown in FIG. 5 were used. Each of these injectors 29 was placed in a half-extended position. The flow valves 52, 53 and 57 for each of these injectors were turned to the fully open position and the reducing agent metering valve 63 for each of these injectors was put in the fully open position. All of the flow valves 52, 53 and 57 for the other injectors 29 and 30 not in use were turned to the close position.

The NOx and ammonia profiles for this fourth configuration of the direct reducing agent injection system at the catalyst exit are shown below:

TABLE 9-1
NOx Profile (ppmvdc) - Direct Injection
System - Config. 4 (Full Load)

| Port | A | B | C | D |
|---|---|---|---|---|
| 7 | 1.3 | 2.0 | 1.2 | 1.6 |
| 6 | 1.3 | 1.4 | 1.0 | 1.0 |
| 5 | 1.5 | 1.8 | 2.0 | 2.5 |
| 4 | 0.9 | 1.0 | 0.7 | 1.1 |
| 3 | 1.3 | 0.9 | 0.8 | 1.1 |
| 2 | 1.4 | 1.0 | 1.0 | 1.3 |
| 1 | 0.8 | 1.0 | 1.3 | 1.4 |

TABLE 9-2
Ammonia Profile (ppmvdc) - Direct Injection
System - Config. 4 (Full Load)

| Port | A | B | C | D |
|---|---|---|---|---|
| 7 | 5.5 | 6.9 | 5.5 | 6.7 |
| 6 | 4.8 | 7.9 | 6.6 | 7.0 |
| 5 | 4.5 | 5.1 | 3.7 | 2.5 |
| 4 | 4.2 | 7.6 | 4.3 | 5.6 |
| 3 | 3.3 | 9.0 | 2.9 | 2.8 |
| 2 | 6.6 | 7.6 | 6.7 | 2.7 |
| 1 | 7.5 | 5.9 | 3.2 | 2.3 |

The average NOx concentration was 1.3 ppmvdc and the average ammonia concentration leaving the catalyst bed was 5.3 ppmvdc. For the fourth configuration of the direct injection system, the ammonia-to-NOx % RMS at the inlet of the catalyst bed was 8.7%.

As shown above, of the four configurations of the reducing agent direct injection system tested, the second configuration, namely the three injectors 29 in the 1, 5 and 9 o'clock positions as shown in FIG. 5 inserted in a half-extended position with the reducing agent metering valve 63 fully open, provided a performance comparable to, if not better than, the conventional reducing agent injection grid, both in the baseline and tuned arrangements. It would be understood by a person skilled in the art that additional configurations of the reducing agent direct injection system could be tested with the gas turbine under full load to determine if any such configurations provide a comparable or better performance than the second configuration discussed above.

### (ii) Partial Load Calibration Testing

### (a) 32 MW Partial Load

A second set of tests were run with the direct injection system with the GE LM6000 PC reduced to a partial load, namely 32 MW. At 32 MW partial load the exhaust gas stream entering the inlet duct has a velocity in the range of approx. 205-210 ft/s and a temperature in the range of approx. 790-810° F.

Since configurations 2 and 4 from the full load testing provided the best results from the full load testing, these two configurations were chosen to investigate the performance of the direct injection system with the gas turbine under partial load.

The NOx and ammonia profiles for the partial load test in the second configuration at the catalyst exit are shown below:

TABLE 10-1
NOx Profile (ppmvdc) - Direct Injection
System - Config. 2 (32 MW Partial Load)

| Port | A | B | C | D |
|---|---|---|---|---|
| 7 | 4.6 | 4.9 | 4.8 | 5.4 |
| 6 | 5.4 | 4.2 | 4.3 | 1.4 |
| 5 | 3.9 | 2.3 | 3.1 | 1.3 |
| 4 | 2.5 | 2.1 | 0.9 | 0.7 |
| 3 | 2.4 | 2.0 | 0.7 | 1.2 |
| 2 | 4.2 | 0.8 | 1.0 | 0.6 |
| 1 | 0.4 | 0.3 | 0.4 | 0.3 |

TABLE 10-2
Ammonia Profile (ppmvdc) - Direct Injection
System - Config. 2 (32 MW Partial Load)

| Port | A | B | C | D |
|---|---|---|---|---|
| 7 | 0.1 | 0.3 | 0.2 | 0.1 |
| 6 | 0.1 | 0.2 | 0.3 | 0.6 |
| 5 | 0.2 | 0.4 | 0.3 | 1.0 |
| 4 | 0.2 | 0.6 | 0.9 | 1.1 |
| 3 | 0.3 | 1.0 | 0.8 | 1.1 |
| 2 | 0.8 | 2.7 | 0.9 | 0.9 |
| 1 | 2.1 | 5.0 | 4.7 | 3.6 |

The average NOx concentration leaving the catalyst bed was 2.4 ppmvdc and the average ammonia concentration leaving the catalyst bed was 1.1 ppmvdc for the second configuration. The ammonia-to-NOx % RMS was 16.1%. As discussed above, at partial load conditions, operating conditions are less stringent than at full load, mainly because of a higher exhaust gas stream residence time within the catalyst. At partial load, the system is less sensitive to ammonia maldistribution. Though the partial load exhaust profile has affected ammonia distribution, the system can still achieve high performance and low ammonia slip.

The NOx and ammonia profiles for the partial load test in the fourth configuration at the catalyst exit are shown below:

TABLE 11-1
NOx Profile (ppmvdc) - Direct Injection
System - Config. 4 (32 MW Partial Load)

| Port | A | B | C | D |
|---|---|---|---|---|
| 7 | 0.8 | 1.8 | 1.2 | 1.2 |
| 6 | 1.2 | 2.1 | 1.5 | 2.4 |
| 5 | 2.0 | 1.6 | 3.7 | 2.2 |
| 4 | 1.5 | 1.1 | 1.9 | 1.9 |
| 3 | 1.5 | 0.6 | 0.4 | 5.2 |
| 2 | 0.7 | 0.4 | 0.6 | 3.9 |
| 1 | 0.2 | 0.5 | 0.6 | 0.5 |

TABLE 11-2
Ammonia Profile (ppmvdc) - Direct Injection
System - Config. 4 (32 MW Partial Load)

| Port | A | B | C | D |
|---|---|---|---|---|
| 7 | 1.4 | 1.0 | 1.5 | 1.1 |
| 6 | 0.6 | 0.6 | 0.7 | 0.2 |
| 5 | 0.5 | 1.1 | 0.4 | 0.3 |
| 4 | 0.5 | 1.8 | 0.5 | 0.2 |
| 3 | 0.4 | 2.6 | 0.9 | 0.1 |
| 2 | 2.4 | 3.2 | 2.1 | 0.1 |
| 1 | 3.3 | 2.4 | 3.0 | 0.8 |

The average NOx concentration leaving the catalyst bed was 1.6 ppmvdc and the average ammonia concentration leaving the catalyst bed was 1.2 ppmvdc. The ammonia-to-NOx % RMS at the inlet of the catalyst bed was 10.8%. Similar to the second configuration, at partial load the ammonia concentrates towards to bottom of the duct.

As shown above, while the ammonia-to-NOx % RMS was not as good for the second and fourth configurations at the 32 MW at partial load, the NOx removal performance remained high and ammonia slip was low. At partial load conditions, operating conditions are less stringent than at full load, mainly because of the exhaust gas stream having a higher residence time within the catalyst bed because of the lower exhaust gas stream velocity. As such, at 32 MW partial load, the system is less sensitive to ammonia maldistribution and can still achieve high performance and low ammonia slip with the higher ammonia-to-NOx % RMS.

It would be understood by a person skilled in the art that additional configurations of the reducing agent direct injection system could be tested to determine if any such configurations provide a performance as good as or better than second and fourth configurations of the direct injection system with the gas turbine in the 32 MW partial load.

### (b) 25 MW Partial Load

A third set of tests were run with load of the GE LM6000 PC reduced further, namely 25 MW. These tests were conducted to confirm the result of the direct injection system at even lower load conditions. At 25 MW partial load the exhaust gas stream entering the inlet duct has a velocity of approx. 195 ft/s and a temperature of approx. 730° F.

As referenced above, under lower load conditions the ammonia-to-NOx % RMS can increase while still maintaining the required performance due largely because of the longer residual time the exhaust gas stream is within the catalyst bed due to the lower velocity of the exhaust gas stream. As such, rather than conducting the full traverse testing, tests were run by measuring the inlet NOx, the stack NOx downstream of the catalyst bed, the inlet ammonia, and the ammonia slip. The tests were run using the conventional injection grid and the direct injection system in the second configuration (three injectors half extended) and the fourth configuration (four injectors half extended) referenced above. The following table summarizes the test results:

TABLE 12
25 MW Partial Load Test Results

| | | Direct | Direct |
|---|---|---|---|
| | Conventional | Injection | Injection |
| | Grid | Conf 2 | Conf 4 |
| Load (MW) | 25 | 25 | 25 |
| Inlet NOx (ppmvdc) | 24.5 | 23.7 | 24.0 |
| Stack NOx (ppmvdc) | 2.0 | 1.6 | 2.0 |
| NOx Conversion (%) | 91.7% | 90.3% | 91.7% |
| Inlet Ammonia | 20.8 | 22.7 | 23.5 |
| (ppmvdc) | | | |
| Ammonia Slip | <1 | 1.1 | 1.5 |
| (ppmvdc) | | | |

As shown above, both the second and fourth configurations of the direct injection system provided performance comparable to the conventional injection grid for the 25 W partial load test. It would be understood by a person skilled in the art that additional configurations of the reducing agent direct injection system could be tested to determine if any such configurations provide a performance as good as or better than configurations 2 and 4 with the gas turbine in partial load.

### Comparison of Model Testing and Full-Size Installation Testing of GE LM6000 PC

As set out above, the results for the model testing for the GE LM6000 PC were validated by the full-size installation testing at similar operating conditions. In particular, the % RMS distributions results from the full-size installation testing in the full load condition were comparable to those demonstrated in the model testing.

For the full load condition testing of the full-size installation, the test results with injectors 29 at the 1, 5 and 9 o'clock positions and half-extended (the second configuration) had a % RMS at the inlet of the catalyst bed of 5.3% and the model testing (Test #1) demonstrated a % RMS of 7.8% for the 20° clockwise swirl angle.

Similarly, for the full load condition testing of the full-size installation, the test results with injectors 29 at the 3, 7 and 11 o'clock positions and half-extended (the third configuration) had a % RMS at the inlet of the catalyst bed of 11.7% and the model testing (Test #3) demonstrated a % RMS of 8.8% for the 20° clockwise swirl angle.

In addition, for the full load condition testing of the full-size installation, the test results for the injectors 29 at the 1, 3, 7 and 9 o'clock positions and half-extended (the fourth configuration) had a % RMS at the inlet of the catalyst bed of 8.7% and the model testing (Test #2) demonstrated a % RMS of 7.7% for the 20° clockwise swirl angle.

Each of the results set out above show a small variation (less than 3% RMS) between the full size test % RMS values and the corresponding model testing while the optimized injector configurations in the full-size tests met the design parameters of catalyst outlet NOx levels and reducing agent slip, and a person skilled in the art would consider this a good correlation between the results of the model testing and the results of the full-size installation testing at full-load operation. In addition, the results demonstrate that by altering the number and position of the nozzles of the injectors, the % RMS distribution at the inlet of the catalyst bed can be varied thereby providing the ability to adjust the injection location(s) of the reducing agent to fine tune the % RMS distribution.

### Model Testing of Solar Titan 130

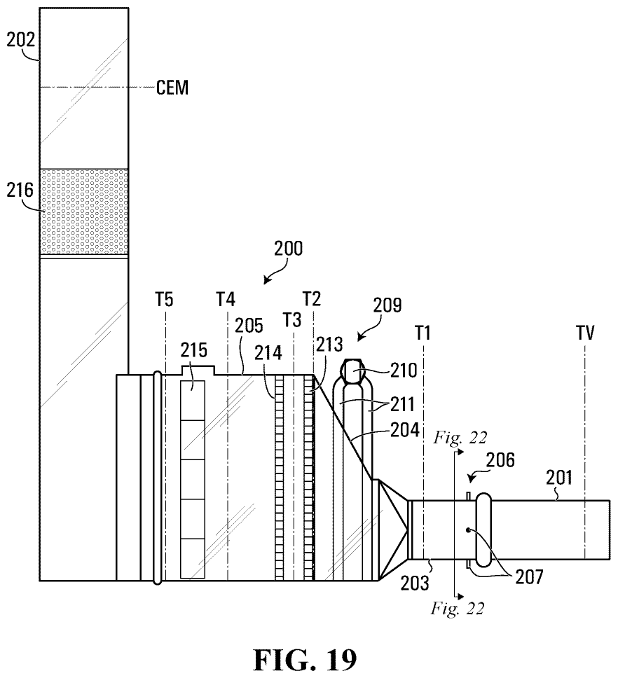

A ⅙ scale model study was conducted of a Solar Titan 130 gas turbine exhaust outlet connected to an SCR catalyst system with a direct reducing agent injection system in accordance with an embodiment of this invention. FIG. 19 to FIG. 23 show the general configuration of the system that was the basis for the model study.

The design criteria for the model were to have an ammonia slip being no greater than 5 ppm and the NOx removal being no less than 90%. Based upon the design of the SCR catalyst system, these criteria required a distribution of the reducing agent at the inlet of the catalyst bed of no greater than 10% RMS in full load conditions. However, as would be understood by a person skilled in the art, different design criteria could be implemented for the SCR catalyst system which could result in a higher or lower % RMS distribution.

### (a) Model Design

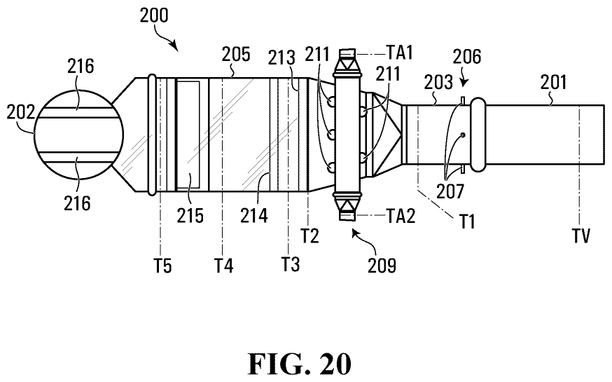

The ⅙ model for the study was constructed of plexiglass. As shown in FIG. 19 and FIG. 20, the SCR catalyst system comprised a duct system 200 connected between a turbine exhaust outlet 201 and a stack 202. The duct system 200 comprises an inlet duct 203, an expansion duct 204 downstream of the inlet duct and a horizontal duct 205 downstream of the expansion duct.

The turbine exhaust outlet 201 was designed to simulate the exhaust gas outlet of a Solar Titan 130 gas turbine based upon the specifications for that turbine. To simulate the exhaust gas flow from the turbine, air in the turbine exhaust outlet 201 was supplied by a centrifugal fan driven by a 30 hp motor. The air supplied to the model was at ambient temperature at approximately 86° F.

The inlet duct 203 included a reducing agent direct injection system 206 comprising a series of injectors 207. As discussed in greater detail below, for the model testing, a tracer gas, namely carbon monoxide, was injected through the injectors 207 to simulate the injection of the liquid reducing agent. Air was also injected with the carbon monoxide to simulate the injection of gas through the nozzle of the injectors 65 in a full-size installation. The injectors 207 included a nozzle at the end designed to spray the mixture of air and tracer gas into the exhaust gas stream flow in a manner that replicated the injection of a liquid reducing agent in a full-size installation. The flow rate of the CO and air being injected through the injectors 207 was controlled with flow meters and pressure gauges and was injected at the appropriate rate in accordance with the momentum flux ratio calculations discussed in greater detail below. Given that the temperature of the exhaust gas turbines outlet in a full-size installation is significantly greater than the boiling points of the liquid reducing agent, the liquid reducing agent is vaporized immediately. As such, the injection for a tracer gas and compressed air in the model at the same momentum flux ratio as the injected liquid reducing agent (which was 19% aqueous ammonia) and compressed air to exhaust gas stream in the full-size installation simulates the injection liquid reducing agent in the full-size installation. As discussed below, the tracer gas concentration was measured across the cross-section of the horizontal duct 205 at the inlet of the catalyst bed simulator to assess the reducing agent distribution at that location in the full-size installation.

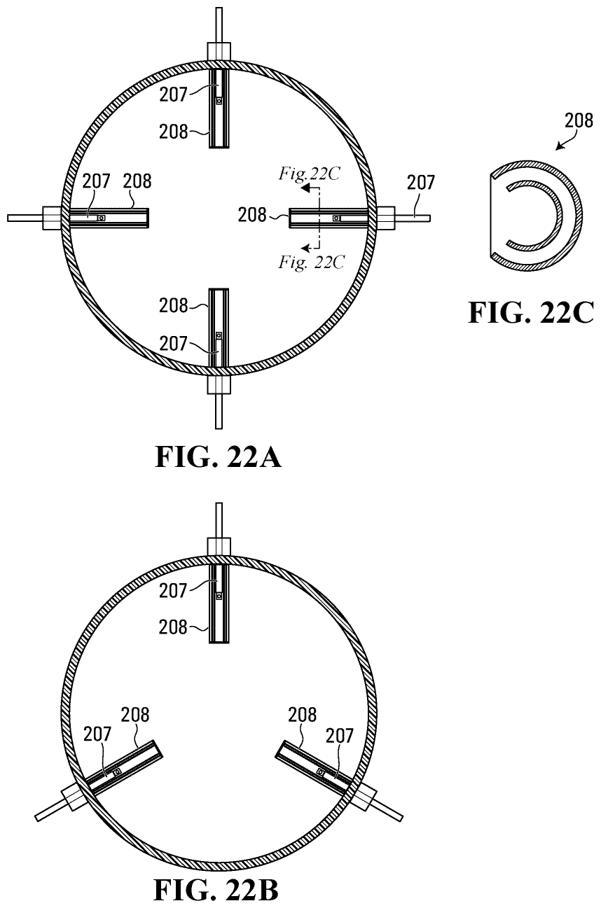

As shown in FIGS. 22A and 22B, two alternative arrangements of the injectors 207 were used in the model testing, namely a four-injector arrangement spaced 90° apart as shown in FIG. 22A and a three-injector arrangement spaced 120° apart as shown in FIG. 22B. In each of the arrangements, a corresponding injector sleeve 208 is positioned around each of the injectors 207. A cross-sectional view of each of the injector sleeves 208 is shown in FIG. 22C. The injector sleeves 208 were designed to replicate the injector sleeve 67 in the full-size installation embodiments discussed above. The number of injectors for this model were reduced as a result of the model and full-size tests conducted for the GE LM6000 PC gas turbine which demonstrated that the use of three or four injectors would likely provide sufficient distribution of the reducing agent in the exhaust gas stream.

Each of the injectors 207 in the model were designed to move radially within the inlet duct 203 to allow for the positioning of its nozzle at different radial locations within the inlet duct 203. For the purpose of the model testing, each of the injectors 207 were inserted such that the nozzle was positioned approximately halfway along the sleeve 208 as generally shown in FIG. 22A and FIG. 22B.

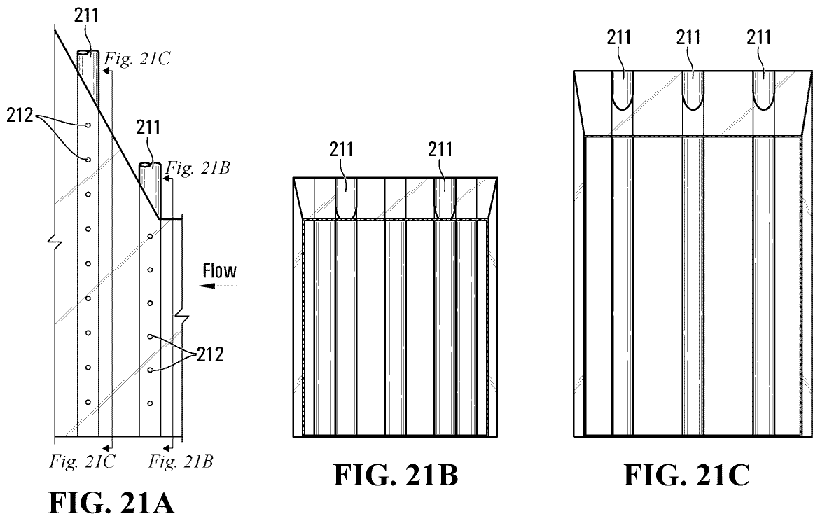

The expansion duct 204 included a tempering air injection system 209 as required for the Solar Titan 130 gas turbine to reduce the temperature of the exhaust gas stream to the effective range of the catalyst bed. As shown in FIG. 19, FIG. 20 and FIG. 21A to C, the tempering air injection system 209 comprised a tempering air header 210 into which ambient tempering air is injected. Two rows of tempering air pipes 211 are connected to the tempering air header 210 and extend downward and into the expansion duct 204. The portions of tempering air pipes 211 within the expansion duct 204 have a series of holes 212 therein. As such, tempering air injected into the tempering air header 210 flows through the tempering air header, into the tempering air pipes 211 and out the series of holes 212 into the exhaust gas stream flowing through the expansion duct 204. In the embodiment shown, the first row of tempering air pipes 211 included two pipes and the second row of tempering air pipes 211 included three pipes downstream of the first row of tempering air pipes. The flow of tempering air was supplied to the tempering air header 210 by a centrifugal fan driven by a 15 hp motor and was supplied at the flow rate discussed below. The air supplied was at ambient temperature of approximately 86° F. The flow rate of the tempering air was calculated to obtain the correct momentum flux ratio between the exhaust gas stream and tempering air as discussed in greater detail below.

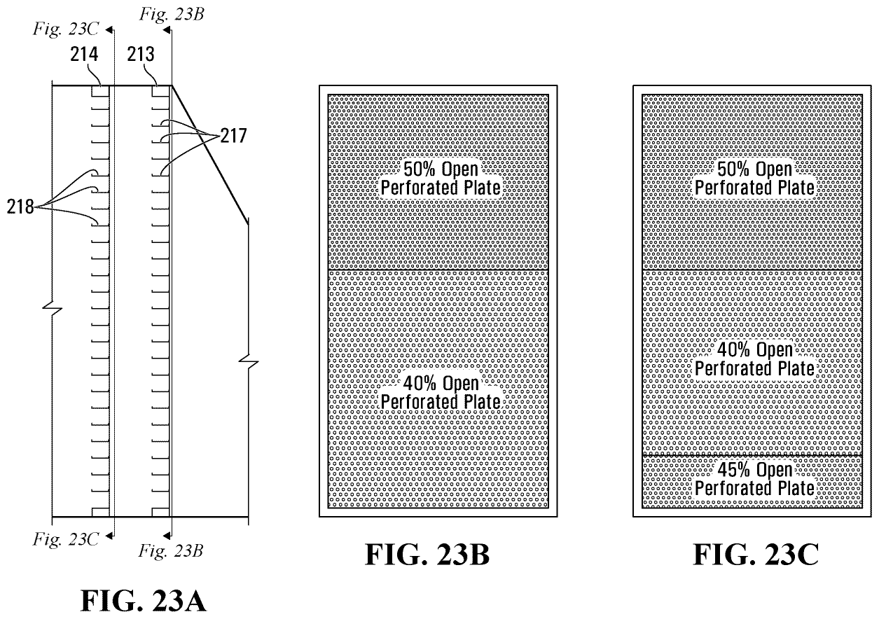

As shown in FIG. 19 and FIG. 23A to FIG. 23C, the horizontal duct 205 includes a first and second flow distribution grid 213 and 214 comprised of perforated metal plates with ¼″ holes. The flow of the exhaust gas stream though each of the first and second flow distribution grids 213 and 214 can be varied by blocking certain holes in the distribution grids with tape which results in the exhaust gas stream only traveling through the unblocked holes.

As such, the flow through each of the distribution grids can be varied to obtain a desired velocity profile downstream of the distribution grids. Both of the first and second flow distribution grids 213 and 214 included conventional flow straighteners 217 and 218 attached on the downstream side in a manner that would be understood by a person skilled in the art.

The horizontal duct 205 also includes a catalyst bed simulator 215 made of sheets of perforated metal plate and eggcrate flow straighteners designed to simulate the pressure loss as the exhaust gas stream flows through the catalyst bed in the full-size installation.

In operation, the exhaust gas stream exiting the turbine exhaust gas outlet 201 passes into the inlet duct 203 through the direct reducing agent injection system 206 before entering the expansion duct 204 where it is mixed with air from the tempering air injection system 209. The mixed exhaust gas stream exiting the expansion duct 204 enters the horizontal duct 205 and passes through the first and second flow distribution grids 213 and 214 and the catalyst bed simulator 215. After passing through the catalyst bed simulator 215, the exhaust gas stream exits through the stack 202. As shown in FIG. 19 and FIG. 20, the stack 202 includes silencer panels 216 made of plywood and skinned with perforated plate to simulate the rough outer surface of silencer panels used in the stack of a full-size installation.

The swirl angles of the exhaust flow leaving the turbine exhaust outlet 201 could be varied between 20° clockwise and 20° counterclockwise to cover a range of load conditions based upon known flow patterns of exhaust gas streams at the outlet of gas turbines. In particular, as referenced above, it is generally understood that an exhaust gas steam at the outlet of a gas turbine operating under a full load condition will typically have a swirl angle of approximately 20° clockwise and an exhaust gas steam at the outlet of a gas turbine operating under a low load condition will typically have a swirl angle of approximately 20° counterclockwise.

### (b) Test Locations

A number of different test locations were used in the model study which are shown in FIG. 19 and FIG. 20 and described in Table 13-1 below:

TABLE 13-1

| Test Location | Description |
|---|---|
| TV | Control Volume |
| TA1 | Tempering Air Inlet Duct |
| T1 | Turbine Exhaust Gas Inlet Duct |
| T2 | First Flow Distribution Grid Inlet |
| T3 | Second Flow Distribution Grid Inlet |
| T4 | Catalyst Bed Simulator Inlet |
| T5 | Catalyst Bed Simulator Outlet |
| CEM | Stack Continuous Emission |
| | Monitoring System |

These test locations were selected at strategic locations to measure the incremental velocity and pressure losses throughout the entire system and tracer gas concentrations to allow for the analysis discussed in greater detail below to be completed.

### (c) Flow Conditions

The model testing was conducted based upon the flow conditions for the Solar Titan 130 gas turbine in full load operation which generates the highest outlet volume flow. These flow conditions were selected as they present the shortest exhaust gas stream residence time within the catalyst bed as well as the highest pressure drop across the duct system given that the exhaust gas stream velocities are the highest. These flow conditions are as follows:

$$\begin{matrix}Full - size Turbine Exhaust Conditions : \\ \begin{matrix}{M}_{Full - size} = 470 , 080 lb / hr \\ {Q}_{Full - size} = 269 , 039 acfm \\ {T}_{Full - size} = 905 ° F \\ {ρ}_{Full - size} = 0.0291 lb / {ft}^{3}\end{matrix}\end{matrix}$$

$$\begin{matrix}Full - size Mixed Conditions : \\ \begin{matrix}{M}_{Full - size} = 511 , 918 lb / hr \\ {Q}_{Full - size} = 280 , 696 acfm \\ {T}_{Full - size} = 843 ° F \\ {ρ}_{Full - size} = 0.0304 lb / {ft}^{3}\end{matrix}\end{matrix}$$

$$\begin{matrix}Full - size Tempering Air Conditions : \\ \begin{matrix}{M}_{Full - size} = 41 , 838 lb / hr \\ {Q}_{Full - size} = 9 , 385 acfm \\ {T}_{Full - size} = 75 ° F \\ {ρ}_{Full - size} = 0.0743 lb / {ft}^{3}\end{matrix}\end{matrix}$$

$$\begin{matrix}Full - size Reducing Agent Conditions : \\ {M}_{Full - size} = 22. lb / hr - ( 19 \% aqueous ammonia )\end{matrix}$$

Where:
   M is the mass flow;
   Q is the flow rate in actual cubic feet per minute;
   T is temperature; and
   ρ is gas density.

The full-size turbine exhaust conditions are the conditions of the exhaust gas stream at the turbine exhaust outlet, the full-size tempering air conditions are the conditions of the tempering air being injected through the tempering air injection system, the full-sized mixed conditions are the conditions of the exhaust gas stream once the tempering air has been injected and the full-size reduction agent conditions are the conditions of the reducing agent being injected into the exhaust gas stream.

### (d) Scaling Parameters and Similitude

This model study was conducted using a geometric linear scale factor of ⅙. As a result, the dimensions and cross-sectional area at each of the testing locations are set out in Table 13-2 below:

TABLE 13-2

| | Full-size | | Model | |
|---|---|---|---|---|
| Location | Dimension (ft) | Area (ft²) | Dimension (ft) | Area (ft²) |
| TV | Dia = 3.43 | 9.21 | Dia = 0.57 | 0.26 |
| TA1 | Dia = 2.38 | 4.43 | Dia = 0.40 | 0.12 |
| T1 | Dia = 5.96 | 27.88 | Dia = 0.99 | 0.77 |
| T2 to T5 | 11.5 × 20.83 | 239.58 | 1.92 × 3.47 | 6.66 |
| CEM | Dia = 9 | 63.62 | Dia = 1.5 | 1.77 |

The duct system at Locations TV, TAI, T1 and CEM have a circular cross-section with “Dia” being the diameter. The duct system at the remainder of the locations has a rectangular cross-section with width by height measurements shown above.

The model study also had an approximate velocity scale of 1/3.8. The velocity scale was based upon a maximum flow rate for the fans used to supply the exhaust stream air and tempering air in the model at the proper momentum ratio as discussed above. As a result, the velocity of the exhaust gas stream at the inlet duct (Location T1 in FIG. 19) in the model was 44 ft/s as compared to 168 ft/s in the full-size installation at the flow conditions set out above.

Also, a comparison between the flow conditions at the inlet of the catalyst bed/catalyst bed simulator inlet (Location T4 in FIG. 19) for a Solar Titan 130 gas turbine at full-load operation in a full-size installation and the model are shown in Table 13-3 below:

TABLE 13-3

| | | |
|---|---|---|
| Flow Conditions at T4 | Full-size | Model |

| | | | | |
|---|---|---|---|---|
| Mass Flow | 511,918 | lb/hr | 8,834 | lb/hr |
| Flow Rate | 280,696 | acfm | 2,065 | acfm |
| Area | 239.58 | ft² | 6.66 | ft² |
| Velocity (Flow rate / Area) | 1,173 | fpm | 310 | fpm |
| Gas Temperature (° F.) | 843° | F. | 86° | F. |
| Gas Density (lb/ft³) | 0.0304 | lb/ft³ | 0.0718 | lb/ft³ |

In gas flow modeling, it is theoretically desirable to simultaneously maintain geometric, kinematic and dynamic similarity. However, such a condition is not possible when using scale models. As such, the scaling factors were chosen using the following rationale in considering these criteria.

When a sufficiently large geometric scaling factor is used the most critical aspect of geometric similarity is satisfied and the reliability of measurements can be obtained. A linear scale of ⅙ was determined to be sufficient to satisfy this criterion and yet be economical to build and test.

Kinematic similarity is dependent upon the Reynolds Number (Re) and has no significant influence on the results if the Reynolds Number is maintained above the minimum value to ensure fully turbulent flow conditions, namely above approximately 20,000 (i.e., the minimum Re to ensure fully turbulent flow conditions). Based on the mean velocity at the catalyst bed inlet/catalyst bed simulator inlet, the Reynolds Numbers for the full-size installation and the model were calculated to be 3.87×10⁵ and 7.42×10⁴ respectively as shown below, thus satisfying the above criteria.

$$Reynolds Number ( Re ) = \frac{VD}{v}$$

Where: V=velocity
   D=characteristic length
   ν=kinematic viscosity of fluid

### Calculation of Re for Full-Size Installation

$$\begin{matrix}V = 1173 / 60 = 19.6 ft / s ( Location T 4 in FIG . 19 ) \\ D = 2 ab / ( a + b ) for a rectangular duct where a = width and b = height \\ = 2 \times 11.5 \times 20.83 / ( 11.5 + 20.83 ) \\ = 14.82 feet \\ v = 7.503 \times {10}^{- 4} {ft}^{2} / s at 843 ° F . \\ {Re}_{Full - size} = \frac{VD}{v} = 3.87 \times {10}^{5}\end{matrix}$$

### Calculation of Re for Model

$$\begin{matrix}V = 310 / 60 = 5.17 ft / s ( Location T 4 in FIG . 19 ) \\ D = 2 ab / ( a + b ) for a rectangular duct where a = width and b = height \\ = 2 \times 1.92 \times 3.47 / ( 1.92 + 3.47 ) \\ = 2.47 feet \\ v = 1.72 \times {10}^{- 4} {ft}^{2} / s at 86 ° F . \\ {Re}_{Full - size} = \frac{VD}{v} = 7.42 \times {10}^{4}\end{matrix}$$

As fully turbulent flow conditions were maintained in the model study, the pressure losses can be measured in the model and predictions made for the full-size installation using the scaling formulae shown below, which is a form of Bernoulli's equation (where P is pressure, V is velocity and ρ is gas density).

$${P}_{Full - size} = {P}_{Model} \times {( \frac{{V}_{Full - size}}{{V}_{Model}} )}^{2} \times \frac{{ρ}_{{Gas}_{Full - size}}}{{ρ}_{{Air}_{Model}}}$$

This particular model study used air of uniform air density for both the exhaust gas stream and the tempering air. The small size of the model makes the forces of gravity negligible in comparison with the inertia forces created by the momentum of the exhaust gas stream air. Therefore, dynamic similarity was not essential to maintain.

As referenced above, in the model testing, ambient air was used for both the exhaust gas stream as well as the tempering air. As such, adjustments were made to the flow rates to account for the different temperatures and densities of the exhaust gas air and tempering air in a full-size installation using a momentum ratio calculated as follows:

### Momentum Ratio—Tempering Air Injection:

$$\frac{{Q}_{hot ( model )}}{{Q}_{cold ( model )}} = \frac{{M}_{hot ( full size )}}{{M}_{cold ( full size )}} \times {( \frac{{ρ}_{Cold ( full size )} \times {ρ}_{cold ( model )}}{{ρ}_{hot ( full size )} \times {ρ}_{hot ( model )}} )}^{1 / 2}$$

Where “hot” is the exhaust gas stream and “cold” is the tempering air.

For the model test, ambient air with a density of 0.0718 1b/ft³ was used both for the exhaust gas stream and the tempering air. Therefore, the momentum ratio used for the exhaust gas stream to the tempering air was calculated as follows:

$$\frac{{Q}_{hot ( model )}}{{Q}_{cold ( model )}} = \frac{470 , 080}{41 , 838} \times {( \frac{0.0743 \times 0.0718}{0.0291 \times 0.0718} )}^{1 / 2}$$

$$\frac{{Q}_{hot ( model )}}{{Q}_{cold ( model )}} = 17.95$$

As discussed above, carbon monoxide was used as the tracer gas injected with compressed air through the injectors. For similarity, the momentum flux ratio between the CO/compressed air mixture with the exhaust gas stream flow in the inlet duct (Location T1 in FIG. 19) in the model was set equal to the momentum flux ratio between the reducing agent (NH₃)/atomizing air mixture with the exhaust gas stream flow in the inlet duct (Location T1 in FIG. 19) of the full-size installation as shown in Table 13-4 below:

TABLE 13-4

| | Units | Full-size | Model |
|---|---|---|---|
| Inlet Duct (T1): | | | |
| Mass Flow | lb/hr | 470,080 | 8,467.30 |
| Volume Flow | acfm | 269,039 | 1,965.48 |
| Gas Temp | deg F. | 905 | 86 |
| Gas Density | lb/ft³ | 0.0291 | 0.0718 |
| Duct Area | ft² | 27.88 | 0.775 |
| Duct Velocity | ft/s | 160.81 | 42.294 |
| Momentum Flux | lb*ft/s² | 20,999 | 99.477 |
| Direct Injection: | | | |
| Mass Flow | lb/hr | 22 | 0.820 |
| Volume Flow | acfm | 8.24 | 0.190 |
| Gas Temp | deg F. | 120 | 86 |
| Gas Density | lb/ft³ | 0.0445 | 0.0718 |
| Mouth Velocity | ft/s | 670 | 85.124 |
| Momentum Flux | lb*ft/s² | 4.0944 | 0.019397 |

| | | |
|---|---|---|
| Momentum Flux Ratio: | 5129 | 5129 |

### (f) Test Results

Traverse testing methodology was used to measure the velocity distribution and distribution of CO at the inlet of the catalyst bed simulator as discussed in greater detail below. In particular, measurements were taken at 28 points across the inlet cross-sectional area of the catalyst bed simulator. Fewer testing points were used as compared to the model of the GE LM6000 PC because of the smaller cross-section area of the catalyst bed simulator. A map of the points looking downstream at the catalyst bed simulator is shown below:

TABLE 13-5

| | A | B | C | D |
|---|---|---|---|---|
| 7 | | | | |
| 6 | | | | |
| 5 | | | | |
| 4 | | | | |
| 3 | | | | |
| 2 | | | | |
| 1 | | | | |

Based upon the measurements at each of the traverse points, the % RMS was calculated as set out above.

### (i) Velocity Distributions & Pressure Loss

The model was first tested to evaluate the velocity distribution at the catalyst bed simulator inlet (Location T4 in FIG. 19). With both flow distribution grids having a baseline porosity of 50% open, the velocity distribution at the catalyst bed simulator inlet (Location T4 in FIG. 19) was non-uniform. Modifications were made to the porosity of the flow distribution grids through an iterative process until a target velocity distribution with an RMS deviation of less than 15% was achieved at the catalyst bed simulator inlet.

The iterative process referenced above resulted in an arrangement in the porosity of the flow distribution grids as shown in FIG. 23B and FIG. 23C. The velocity distribution at the catalyst bed simulator inlet (Location T4 in FIG. 19) was measured with the flow distribution grids configured as shown in FIG. 23B and FIG. 23C for each of the turbine outlet swirls. All the distributions were acceptable with % RMS less than 12% (which was within the target criteria of less than 15%) as shown in Table 13-6 below:

TABLE 13-6
20° CW SWIRL

| | | | | | Row |
|---|---|---|---|---|---|
| | A | B | C | D | Averages |
| 7 | 91 | 99 | 101 | 101 | 98 |
| 6 | 99 | 105 | 105 | 109 | 105 |
| 5 | 113 | 109 | 107 | 109 | 110 |
| 4 | 91 | 109 | 99 | 76 | 94 |
| 3 | 91 | 97 | 113 | 79 | 95 |
| 2 | 101 | 97 | 101 | 93 | 98 |
| 1 | 81 | 91 | 109 | 115 | 99 |
| Column | 96 | 101 | 105 | 98 | |
| Averages | | | | | |
| % RMS = 10.1% of the Mean Velocity | | | | | |
| 20° CCW SWIRL | | | | | |
| | | | | | Row |
| | A | B | C | D | Averages |
| 7 | 79 | 97 | 97 | 99 | 93 |
| 6 | 103 | 105 | 107 | 112 | 107 |
| 5 | 105 | 107 | 109 | 114 | 109 |
| 4 | 85 | 101 | 105 | 91 | 96 |
| 3 | 85 | 107 | 103 | 89 | 96 |
| 2 | 103 | 112 | 97 | 99 | 103 |
| 1 | 59 | 114 | 97 | 114 | 96 |
| Column | 89 | 106 | 103 | 103 | |
| Averages | | | | | |

% RMS = 11.9% of the Mean Velocity

The estimated static pressure loss from the turbine outlet to atmosphere with the flow distribution grids installed as shown in shown in FIG. 23B and FIG. 23C was calculated to be 2.16 inches of water column static pressure. This pressure loss across the system was well within the acceptable range of below 12 inches of water column of static pressure. This pressure loss assumed design pressure loss across the SCR catalyst and did not include stack draft.

### (ii) Direct Reducing Agent Injection

As referenced above, the direct reducing agent injection was tested by injecting a tracer gas, namely carbon monoxide gas along with air through the simulated reducing agent injectors. The flowrate of the mixture of carbon monoxide and air used in the model was based on the momentum flux ratio calculations set out above.

The distribution of the carbon monoxide gas was then measured at the catalyst bed simulator inlet (Location T5 in FIG. 15) using a multi-gas sampler with a sampling probe that had an accuracy of +/−1%. Sufficient carbon monoxide was included in the mixture to be detected by this device.

The distribution of the carbon monoxide gas at the catalyst bed simulator inlet (Location T4 in FIG. 19) with three (3) reducing agent injectors for each of the turbine swirls are shown in Table 13-7 below:

TABLE 13-7
20° CW SWIRL
Concentrations (PPM)

| | A | B | C | D |
|---|---|---|---|---|
| 7 | 135 | 138 | 140 | 142 |
| 6 | 141 | 142 | 141 | 142 |
| 5 | 146 | 142 | 134 | 135 |
| 4 | 148 | 145 | 130 | 131 |
| 3 | 148 | 147 | 127 | 126 |
| 2 | 144 | 151 | 145 | 126 |
| 1 | 147 | 158 | 163 | 148 |

Mean Concentration = 142 PPM
% RMS = 6.2% of Mean Concentration
20° CCW SWIRL

Concentrations (PPM)

| | A | B | C | D |
|---|---|---|---|---|
| 7 | 142 | 145 | 144 | 148 |
| 6 | 148 | 142 | 139 | 145 |
| 5 | 143 | 140 | 133 | 141 |
| 4 | 141 | 139 | 132 | 132 |
| 3 | 145 | 144 | 134 | 127 |
| 2 | 145 | 143 | 140 | 134 |
| 1 | 146 | 145 | 140 | 132 |

Mean Concentration = 140 PPM
% RMS = 3.9% of Mean Concentration

The distribution of the carbon monoxide gas at the catalyst bed simulator inlet (Location T4 in FIG. 19) with four (4) reducing agent injectors for each of the turbine swirls are shown in Table 13-8 below:

TABLE 13-8
20° CW SWIRL
Concentrations (PPM)

| | A | B | C | D |
|---|---|---|---|---|
| 7 | 142 | 138 | 136 | 129 |
| 6 | 142 | 135 | 131 | 125 |
| 5 | 144 | 136 | 126 | 121 |
| 4 | 143 | 138 | 121 | 118 |
| 3 | 132 | 137 | 127 | 119 |
| 2 | 126 | 140 | 149 | 130 |
| 1 | 131 | 154 | 169 | 155 |

Mean Concentration = 136 PPM
% RMS = 8.6% of Mean Concentration
20° CCW SWIRL

Concentrations (PPM)

| | A | B | C | D |
|---|---|---|---|---|
| 7 | 134 | 137 | 143 | 145 |
| 6 | 136 | 135 | 136 | 143 |
| 5 | 128 | 131 | 135 | 143 |
| 4 | 124 | 129 | 136 | 142 |
| 3 | 128 | 133 | 138 | 134 |
| 2 | 143 | 150 | 145 | 135 |
| 1 | 156 | 163 | 156 | 140 |

Mean Concentration = 139 PPM
% RMS = 6.4% of Mean Concentration

As shown above, the 20° clockwise turbine outlet swirl for each of the three injector arrangements had an % RMS deviation below the design criteria of no greater than 10% at full load operation. As referenced above, this was achieved with the velocity of the exhaust gas stream at the inlet duct (Location T1 in FIG. 15) being 44 ft/s. These distributions were also below the range of 9.5-13% obtained in model testing of SCR catalyst systems with conventional reducing agent injection grids upstream of the catalyst bed.

In addition, the 20° counterclockwise turbine outlet swirl for each of the three injector arrangements had an % RMS deviation below the design criteria of no greater than 10% at full load operation.

### Concluding Comments on Testing

The model and full-size installation testing conducted as discussed above demonstrated that embodiments of the invention provide the target no greater than 10% RMS distribution of the reducing agent at the inlet of the catalyst bed in full load condition to meet the design criteria of an ammonia slip being no greater than 5 ppm and the NOx removal being no less than 90%. The GE LM6000 PC full-size installation testing also demonstrated that the system continued to meet the design criteria of an ammonia slip being no greater than 5 ppm and the NOₓ removal being no less than 90% when the system was operated under partial load and low load conditions.

In addition, as referenced above, the model testing was conducted at velocities of the exhaust gas stream at the inlet duct that were at a fraction of the velocities at the inlet duct of a full-size installation, while still being large enough to maintain turbulent flow at that inlet of the catalyst bed. For example, the GE LM6000 PC model tests were conducted at a T1 velocity of 82 ft/s, modelling a full-size installation operating at 274 ft/s. Similarly, the Solar Titan 130 model tests were conducted at a T1 velocity of 44 ft/s, modelling a full-size system operating at 167 ft/s. Both the model and full-size velocities were much above the threshold 20,000 Reynold's number for turbulent flow at the inlet of the catalyst bed simulator/catalyst bed. As fluid flow theory indicates that the % RMS reducing agent distribution is maintained over the range of Reynold's numbers as long as turbulent flow is achieved (Re>20,000), a person skilled in the art can conclude that even at an increased Reynold's number of 60,000 (safety factor of 3) or full-size exhaust flow velocity at approximately 52 ft/s for the GE LM6000 PC and approximately 29 ft/s for the Solar Titan 130, the % RMS distribution for reducing agent will be maintained. As such, it would be understood by a person skilled in the art that SCR catalyst systems with direct injection systems according to an embodiment of the invention can meet design criteria similar to or better than a conventional reducing agent injection grid when the turbine is operating in a full load condition for all of the gas turbines listed in Table 1 above.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but it is to be limited only by the scope of the attached claims, including the full range of equivalency to which each element thereof is entitled. By way of example, the invention is not limited to the injector design, arrangement and/or location as set out in the above-noted embodiments but rather may include other injector designs, arrangements and/or locations which utilize the temperature, velocity and/or turbulence of the exhaust gas stream to vaporize the liquid reducing agent and distribute the vaporized reducing agent across the exhaust gas stream to achieve the desired reduction of NOx as the exhaust gas stream passes through the catalyst bed while maintaining the reducing agent slip within specified ranges.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiments disclosed, but that the invention will include all embodiments falling within the scope of the appended claims.

1. A method of removing a portion of at least one type of nitrogen oxide from an exhaust gas stream flowing through a duct system, the method comprising:
providing at least one injector for injecting a reducing agent into the exhaust gas stream at a point of injection wherein the exhaust gas stream is flowing with a flow turbulence at or after the point of injection causing the reducing agent to be distributed within the exhaust gas stream wherein
the at least one injector comprises a nozzle for injecting the reducing agent into the exhaust gas stream; and
the at least one injector can be adjusted to selectively position the nozzle at a plurality of locations within the exhaust gas stream;
passing the exhaust gas stream through an expansion zone in the duct system to a reduced velocity;
passing the exhaust gas stream at the reduced velocity through a catalyst bed wherein the catalyst enables a reaction between the vaporized reducing agent and the at least one type of nitrogen oxide to remove a portion of the at least one type of nitrogen oxide from the exhaust gas stream.

2. The method of claim 1 wherein the reducing agent is, at least in part, a liquid when injected into the exhaust gas stream and the exhaust gas stream has a temperature at or after the point of injection that is greater than the vaporization temperature of the liquid reducing agent such that the liquid reducing agent is vaporized in the exhaust gas stream.

3. The method of claim 2 further comprising passing the exhaust gas stream at the reduced velocity through a distribution grid prior to the catalyst bed to distribute the velocity of the exhaust gas stream across the cross-sectional area of the catalyst bed.

4. The method of claim 3 wherein the exhaust gas stream has a velocity in excess of about 29 ft/s at or after the point of injection of the liquid reducing agent at a full load condition.

5. The method of claim 2 further comprising:
measuring a first distribution of the reducing agent upstream of the catalyst bed;
changing the position of the nozzle of the at least one injector within the exhaust gas stream;
measuring a second distribution of the reducing agent upstream of the catalyst bed;
comparing the first distribution and the second distribution to determine a preferred location of the nozzle within the exhaust gas stream.

6. An apparatus for removing a portion of at least one type of nitrogen oxide from an exhaust gas stream, the apparatus comprising:
a duct system through which the exhaust gas stream flows;
at least one injector for injecting a reducing agent into the exhaust gas stream at a point of injection wherein the exhaust gas stream is flowing with a flow turbulence at or after the point of injection causing the reducing agent to be distributed within the exhaust gas stream wherein
the at least one injector comprises a nozzle for injecting the reducing agent into the exhaust gas stream; and
the at least one injector can be adjusted to selectively position the nozzle at a plurality of locations within the exhaust gas stream;
an expansion zone in the duct system that reduces the velocity of the exhaust gas stream to a reduced velocity; and
a catalyst bed positioned downstream of the expansion zone wherein the catalyst enables a reaction between the vaporized reducing agent and the at least one type of nitrogen oxide to remove a portion of the at least one type of nitrogen oxide from the exhaust gas stream.

7. The apparatus of claim 6 wherein the reducing agent is, at least in part, a liquid when injected into the exhaust gas stream and the exhaust gas stream has a temperature at or after the point of injection that is greater than the vaporization temperature of the liquid reducing agent such that the liquid reducing agent is vaporized in the exhaust gas stream.

8. The apparatus of claim 7 further including a distribution grid in the duct system positioned upstream of the catalyst bed to distribute the velocity of exhaust gas stream across the cross-sectional area of the catalyst bed.

9. The apparatus of claim 8 wherein the exhaust gas stream has a velocity in excess of about 29 ft/s at or after the point of injection of the liquid reducing agent at a full load condition.

10. The apparatus of claim 8 wherein the exhaust gas stream has a velocity in excess of about 29 ft/s at or after the point of injection of the liquid reducing agent at a full load condition:
at least one injector comprising a reducing agent inlet for receiving the reducing agent and a nozzle for injecting the reducing agent into the exhaust gas stream,
a reducing agent supply line fluidly connected to the reducing agent inlet of the at least one injector for supplying the reducing agent to the injector; and
at least one injector assembly to selectively position the nozzle of the injector at a plurality of locations within the exhaust gas stream.

11. The apparatus of claim 10 wherein the reducing agent is a liquid reducing agent and further comprising:
at least one coolant system to insulate at least a portion of the at least one injector from the exhaust gas stream to prevent vaporization of the liquid reducing agent prior to being injected from the nozzle into the exhaust gas stream.

12. The apparatus of claim 11 further comprising:
an injector gas supply line fluidly connected to the at least one injector; and
wherein the at least one injector further comprises a gas channel through which gas from the injector gas supply line flows and is mixed with the liquid reducing agent prior to the liquid reducing agent being injected from the nozzle into the exhaust gas stream

13. The apparatus of claim 12 wherein the at least one cooling system comprises:
at least one sleeve position within the duct wherein at least a portion of the at least one injector extends axially within the sleeve;
a cooling gas supply line fluidly connected to the at least one sleeve;
at least one axial cooling gas channel in the sleeve that extends around at least a portion the injector;
wherein cooling gas flows from the cooling gas supply line through said at least one cooling channel to insulate at least a portion of the at least one injector;
and wherein the sleeve further comprises a window through which the liquid reducing agent injected from the nozzle passes through and into the exhaust gas stream.

14. The apparatus of claim 13 wherein:
the at least one injector assembly has channel and a clamping mechanism;
the at least one injector extends axially through the channel of the at least one injector assembly; and
the clamping mechanism has an unlocked position wherein the at least one injector can move axially within the channel of the at least one injector assembly and a locked position wherein the at least one injector is secured within the channel of the at least one injector assembly.

15. The apparatus of claim 14 wherein the clamping mechanism further comprises a seal to frictionally engage and seal the at least one injector in the channel of the at least one injector assembly when the clamping mechanism is in the locked position.

16. The apparatus of claim 10 wherein:
the at least one injector comprises a plurality of injectors;
the reducing agent comprises a liquid reducing agent;
the at least one injector assembly comprises a plurality of injector assemblies corresponding to each of the plurality of injectors; and
wherein the apparatus further comprises a plurality of reducing agent valves corresponding to each of the plurality of injectors arranged to selectively allow the liquid reducing agent to flow from the reducing agent supply line into each of the plurality of injectors.

17. The apparatus of claim 16 further comprising:
a coolant system to insulate at least a portion of each of the plurality of injectors from the exhaust gas stream to prevent vaporization of the liquid reducing agent prior to being injected from the nozzle into the exhaust gas stream.

18. The apparatus of claim 17 further comprising:
an injector gas supply line fluidly connected to each of the plurality of injectors;
wherein each of the plurality of injectors further comprises a gas channel through which gas from the injector gas supply line flows and is mixed with the liquid reducing agent prior to the liquid reducing agent being injected from the nozzle into the exhaust gas stream.

19. The apparatus of claim 18 wherein:
the cooling system comprises:
a plurality of sleeves position within the duct and corresponding to each of the plurality of injectors wherein at least a portion of the injector extends axially within the corresponding sleeve;
a cooling gas supply line fluidly connected to the plurality of sleeves;
at least one axial cooling gas channel in each of the plurality of sleeves that extends around at least a portion the corresponding injector that extends axially therein;
wherein cooling gas flows from the cooling gas supply line through each of the cooling gas channels to insulate at least a portion of the corresponding injector that extends axially therein;
and wherein the plurality of sleeves further comprises a window through which the liquid reducing agent injected from the nozzle passes through and into the exhaust gas stream.

20. The apparatus of claim 19 wherein:
each of the plurality of injector assemblies has channel and a clamping mechanism; each
of the injectors extend axially through the channel of the corresponding injector assembly; and
the clamping mechanism has an unlocked position wherein the injector can move axially within the channel of the injector assembly and a locked position wherein the injector is secured within the channel of the injector assembly wherein the clamping mechanism of each of the plurality of injector assemblies further comprises a seal to frictionally engage and seal the corresponding injector in the channel when the clamping mechanism is in the locked position.
